SEQUENCE LISTING (22 sequences)

SEQ ID NO: 1 - protein, 90 aa, Artificial sequence
  Synthetic polypeptide
GAGAGSGAGAGSGAGAGSGAGAGSGAGAGSGAGAGSGAGAGSGAGAGSGAGAGSGAGAGSGAGAGSGAGAGSGAGAGSGAGAGSGAGAGS

SEQ ID NO: 2 - protein, 30 aa, Artificial sequence
  Synthetic polypeptide
GXGXGXGXGXGXGXGXGXGXGXGXGXGXGX

SEQ ID NO: 3 - protein, 4 aa, Bombyx mori
GAAS

SEQ ID NO: 4 - protein, 15 aa, Artificial sequence
  Synthetic polypeptide
SSAAAAAAAAAAAAA

SEQ ID NO: 5 - protein, 8 aa, Artificial sequence
  Synthetic polypeptide
GXXXXGGX

SEQ ID NO: 6 - protein, 4 aa, Artificial sequence
  Synthetic polypeptide
GGGX

SEQ ID NO: 7 - protein, 12 aa, Artificial sequence
  Synthetic polypeptide
SSAAAASSAAAA

SEQ ID NO: 8 - protein, 6 aa, Galleria mellonella
GLGGLG

SEQ ID NO: 9 - protein, 6 aa, Artificial sequence
  Synthetic polypeptide
GXGGXG

SEQ ID NO: 10 - protein, 21 aa, Artificial sequence
  Synthetic polypeptide
GPGGXGPGGXGPGGXGPGGXY

SEQ ID NO: 11 - protein, 5 aa, Argiope trifasciata
GRGGA

SEQ ID NO: 12 - protein, 13 aa, Artificial sequence
  Synthetic polypeptide
GAGAAAAAAAGGA

SEQ ID NO: 13 - protein, 8 aa, Artificial sequence
  Synthetic polypeptide
GGXGXGXX

SEQ ID NO: 14 - protein, 16 aa, Bombyx mori
TGSSGFGPYVNGGYSG

SEQ ID NO: 15 - protein, 8 aa, Bombyx mandarina
YEYAWSSE

SEQ ID NO: 16 - protein, 7 aa, Antheraea mylitta
SDFGTGS

SEQ ID NO: 17 - protein, 7 aa, Antheraea yamamai
RRAGYDR

SEQ ID NO: 18 - protein, 8 aa, Galleria mellonella
EVIVIDDR

SEQ ID NO: 19 - protein, 18 aa, Nephila madascariensis
TTIIEDLDITIDGADGPI

SEQ ID NO: 20 - protein, 8 aa, Major ampullata
TISEELTI

SEQ ID NO: 21 - protein, 6 aa, Artificial sequence
  Synthetic polypeptide
GSGAGA

SEQ ID NO: 22 - protein, 5 aa, Artificial sequence
  Synthetic polypeptide
GPGXX

(19) United States
(12) Patent Application Publication
(10) Pub. No.: US 2013/0243693 A1
(43) Pub. Date: Sep. 19, 2013

(54) SILK OPTICAL PARTICLES AND USES THEREOF

(71) Applicants: Fiorenzo Omenetto, Wakefield, MA (US); David Kaplan, Concord, MA (US)

(72) Inventors: Fiorenzo Omenetto, Wakefield, MA (US); David Kaplan, Concord, MA (US)

(73) Assignee: TUFTS UNIVERSITY, Medford, MA (US)

(21) Appl. No.: 13/704,975

(22) PCT Filed: Jun. 17, 2011
(86) PCT No.: PCT/US11/41002

§ 371 Date: Jun. 4, 2013

Related U.S. Application Data
(60) Provisional application No. 61/355,583, filed on Jun. 17, 2010.
(60) Provisional application No. 61/434,691, filed on Jan. 20, 2011.

(51) Int. Cl. G02B 1/04; G02B 5/18

(52) U.S. Cl. CPC G02B 1/04; G02B 5/1809
USPC 424/9.1; 359/558; 359/569; 424/400; 424/401

(57) ABSTRACT

Disclosed herein are methods of preparing silk particles having at least one optical property, e.g., reflectivity, diffraction, refraction, absorption, optical-gain, fluorescence, and light scattering, and compositions resulted therefrom. The compositions and methods of the invention can be utilized in various applications, e.g., medical applications, cosmetics, sunscreen and food additives.

### RELATED APPLICATIONS

This application claims priority to U.S. Provisional Application No. 61/355,583, entitled “Silk Optical Powders” and filed Jun. 17, 2010 and U.S. Provisional Application No. 61/431,691, entitled “Silk Optical Powders and Uses Thereof” and filed Jan. 20, 2011, the contents of which are hereby incorporated by reference in their entirety.

### BACKGROUND

Various consumer products in the market today provide a glitter effect for attractiveness. For example, skincare and/or cosmetics products such as lip balms, foundation, and lotions contain sparkling particles to enhance skin complexion after application. Typically, such effect is obtained by using inorganic additives such as silica, titanium dioxide, mica, iron oxides and the like. In addition, wax coatings are usually present on fresh food produce such as fruits and vegetables to make them look better and retain moisture. In such cases, petroleum-based waxes including paraffin, mineral oil, and polyethylene are sometimes used.

While these additives or coatings are generally regarded safe, they are still synthetic and involve the use of heavy metals or hydrocarbons, which may cause adverse side-effects for long-term use or ingestion. As an alternative, silk powder, derived from pure silk worm cocoon, has been used as an additive to food products, beverages and cosmetic products. Natural silk is biocompatible and degradable, but its inherent optical property (e.g., the ability to change color) and/or degradation rate cannot be controlled. As such, there is a need to overcome these limitations and expand the utility of silk powder in various applications. For instance, while synthetic chemicals are being used as a contrast agent for biomedical imaging, silk powder could be potentially an ideal agent to be used because it is natural, biocompatible and biodegradable. However, its optical and biodegradable properties have to be designed for such use. Thus, there also remains a need in the art of biomedical imaging field to develop biocompatible, biodegradable and/or bioresorbable photonic components and agents that need no retrieval after injection into the body, and at the same time, provide high-quality optical properties and sensitivities.

### SUMMARY OF THE DISCLOSURE

The present disclosure encompasses the insight that particle compositions can be prepared from certain silk materials such as silk films, and that such particle compositions have particularly desirable attributes for incorporation into a variety of products, including, for example, cosmetics, food additives, imaging agents (e.g., contrast dyes for medical imaging), etc. According to the present invention, particle compositions are prepared from silk films, and in particular from silk films having certain optical characteristics. The present invention appreciates that rendering particles from such silk films achieves particle compositions with unusual and desirable properties including optical properties, biocompatibility properties and biodegradability properties. The present invention provides such particle compositions, methods of making and using them, products into which they are incorporated, etc., as well as systems for characterizing, analyzing, and or selecting appropriate films and/or particle compositions.

Among other things, provided herein are methods of preparing silk optical particle compositions, e.g., powders, etc, as well as product comprising such composition for use in various applications. In one aspect, provided compositions include silk particles having (e.g., selected and/or engineered to have) at least one optical property, e.g., reflectivity, diffraction, refraction, absorption, optical gain fluorescence, and light scattering. In some embodiments, desirable silk particle compositions are prepared and/or selected by a process including steps of: (a) providing a solid-state silk fibroin having the at least one optical property; and (b) generating particles from the solid-state fibroin. In some embodiments, the solid-state silk fibroin, e.g., a silk film, is a replica of a master pattern having at least one optical structure. In some embodiments, the process can further comprise additional treatment of the solid-state silk fibroin, e.g., chemical or mechanical treatments for altering one or more optical and/or degradation properties of the silk particles.

In various embodiments, silk particles and/or particle compositions can further comprise a polymer and/or other agent, e.g., a biocompatible and/or a biodegradable agent. In some embodiments, silk particles and/or particle compositions can be comprised of non-naturally-occurring silk materials (e.g., of silk proteins that contain one or more structural modifications as compared with a reference natural silk protein, which is known in the art. In general, a modified silk protein will typically show at least about 85%, 90%, 95% overall sequence identity with a reference natural silk protein and/or will share one or more characteristic sequence elements with the reference natural silk proteins.

In some embodiments, a modified silk protein has altered optical properties as compared with the reference natural silk protein.

In some embodiments of the invention, provided compositions include particles other than silk particles (i.e., non-silk particles). Examples of non-silk particles include protein particles, inorganic particles, polymeric particles, or a combination thereof.

Another aspect of the invention relates to product compositions comprising provided silk particle compositions, for various applications. Non-limiting examples of such product compositions include pharmaceutical compositions, e.g., for in vivo administration; optical contrast agents, e.g., for biomedical imaging; food additives, cosmetics, etc.

Other compositions comprising silk optical particles described herein are also within the scope of the invention. For example, an article of manufacturer bearing one or more optical effects can be selected from the group consisting of toys, arts, crafts, ornamental objects, paints, inks, apparel, textiles, hair care products, paper products, edible products, cosmetics, lens, signs, and displays. An optical coating comprising the silk optical particles described herein can be applied to a material, for example to food produce or on an energy-harvesting device, e.g., a solar cell.

Cosmetic compositions comprising provided silk particle compositions described herein are also provided herein. In some embodiments, a cosmetic composition can exist in a form of a powder, pressed powder, liquid, emulsion, cream, lotion, gel, aerosol, ointment, or solid stick. In some embodiments, the reflected wavelength of the silk particles can be in a range comparable to the reflected wavelength of a skin complexion, thereby enhancing the appearance of the desired skin complexion. In some embodiments, the reflected wavelength of the silk particles can be in a range comparable to the wavelengths of one or more desired colors. In additional embodiments, the silk particles can impart an iridescence effect. Accordingly, another aspect of the invention relates to methods of improving appearance of human skin complexion. The method includes the steps of providing the cosmetic composition described herein; and applying the cosmetic composition on human skin to improve appearance of the human skin complexion.

In yet another aspect, sunscreen compositions for protecting epidermis or hair against UV rays are provided herein. The sunscreen composition comprises the silk optical particles described herein, and at least one cosmetically or pharmaceutically acceptable carrier. In some embodiments, the sunscreen composition described herein can further comprise non-silk particles, e.g., particles that absorb or reflect UV rays. In some embodiments, the silk particles can be modified to have an amino acid sequence enriched in at least one type of amino acids that absorb or reflect UV rays.

A further aspect of the invention relates to methods of protecting an object against a pre-determined wavelength of light. In some embodiments, the pre-determined wavelength of light can correspond to ultra-violet or visible light. The method includes the steps of providing at least one composition described herein, e.g., cosmetic composition; and applying the composition on the object to protect it against the pre-determined wavelength of light. Exemplary objects include, but are not limited to, epidermis, hair, or any photosensitive objects such as chemical compounds, antiques, arts, crafts, paper products, apparel, textiles, packaging materials, and edible products, kits, e.g., useful in biomedical fields, are also provided. Such kits comprise the pharmaceutical composition or the optical contrast agent described herein, and a pharmaceutically acceptable solution. In one embodiment, the kit further includes at least one syringe. In one embodiment, the kit further includes at least one catheter.

### BRIEF DESCRIPTION OF THE DRAWING

FIGS. 1 and 2 depict exemplary silk films with arrays of lenses;

FIG. 3 depicts an exemplary lens;

FIG. 4 depicts an exemplary lens with patterned concentric rings formed on its surface;

FIGS. 5 and 6 depict exemplary silk films with diffraction gratings;

FIG. 7 depicts diffracted orders from a laser impinging on an exemplary silk film with a diffraction grating;

FIG. 8 depicts diffracted orders from a laser impinging on a silk filk with a diffraction grating with a pitch of 1,200 lines/mm;

FIGS. 9 and 10 depict exemplary patterns of light transmitted through other silk films with diffractive gratings;

FIG. 11 depicts a patterned silk film 1100 that functions as a photonic bandgap;

FIGS. 12 and 13 depict portions of patterned silk films on which an array of holes has been machined;

FIGS. 14 and 15 depict exemplary photonic crystals formed by stacking patterned silk films;

FIGS. 16 and 17 depict exemplary microprisms on silk films;

FIG. 18 depicts an exemplary silk film with a diffraction grating;

FIG. 19 depicts an exemplary silk optical powder formed from a silk film with a diffraction grating; and

FIG. 20 depicts an exemplary silk film that can be used to create particles that exhibit colors.

### DETAILED DESCRIPTION OF CERTAIN EMBODIMENTS

The present invention encompasses the insight that particle compositions can be prepared from certain silk materials such as silk films, and that such particle compositions have particularly desirable attributes for incorporation into a variety of products, including, for example, cosmetics, food additives, imaging agents (e.g., contrast dyes for medical imaging), etc. As used herein, the phrase “particle composition” refers to a collection or population of particles. In some embodiments, a particle composition is a homogeneous population of particles having an essentially uniform set of properties. In some embodiments, a particle composition is a heterogeneous population of particles having non-uniform set of properties. For example, in some embodiments, a particle composition comprises particles of different sizes, different materials, etc.

The present invention among other things provides methods of preparing silk optical particle compositions, e.g., powders, etc, as well as product comprising such composition for use in various applications. In one aspect, provided compositions include silk particles having (e.g., selected and/or designed or engineered to have) at least one optical property, e.g., reflectivity, diffraction, refraction, absorption, optical gain fluorescence, and light scattering.

Silk Fibroin

Silk fibroin is a particularly appealing biopolymer candidate to be used for embodiments of the invention because of its optical properties (Lawrence et al., 9 Biomacromolecules 1214 (2008)), mechanical properties (Altman et al., 24 Biomat. 401 (2003); Jiang et al., 17 Adv. Funct. Mater. 2229 (2007)), all aqueous processing (Sofia et al., 54J. Biomed. Mater. Res. 139 (2001); Perry et al., 20 Adv. Mater. 3070-72 (2008)), relatively easy functionalization (Murphy et al., 29 Biomat. 2829-38 (2008)), and biocompatibility (Santin et al., 46 J. Biomed. Mater. Res. 382-9 (1999)). For example, silk fibroin can be processed into thin, mechanically robust films with excellent surface quality and optical transparency. Such silk films can then be processed to have micro- and nano-scale patterning upon its surface to generate desirable optical properties. The present invention encompasses the recognition that these optical properties provided on silk films can be retained when the film is reduced to particles (e.g., microparticles and nanoparticles) and resulting silk particle compositions having the optical properties can be used in a wide variety of applications.

Silk has been used in human implants as a U.S. Food and Drug Administration approved tissue engineering scaffold. Altman et al., 24 Biomaterials: 401 (2003). Reprocessed silk has been recently shown to be suitable as a material platform to manufacture sophisticated optical components with features on the micro- and nanoscale. Amsden et al., 22 Adv. Mater. 1-4 (2010); Lawrence et al., 9 Biomacromolecules 1214 (2008); Omenetto & Kaplan, 2 Nat. Photonics 641 (2008); Perry et al., 20 Adv. Mater. 3070 (2008). Optical components made from the free-standing reprocessed silk are refractive or diffractive, and comprise elements ranging from microlens arrays, white light holograms, to diffraction gratings and planar photonic crystals with minimum feature sizes of less than 20 nanometers. These components, which are entirely constituted by silk, possess properties needed to provide mechanically stable, high-quality optical elements that are fully degradable, biocompatible and implantable. Omenetto & Kaplan, 2008.

As used herein, the term “silk fibroin” includes silkworm fibroin and insect or spider silk protein. See e.g., Lucas et al., 13 Adv. Protein Chem. 107 (1958). Any type of silk fibroin may be used according to the present invention. Silk fibroin produced by silkworms, such as Bombyx mori, is the most common and represents an earth-friendly, renewable resource. For instance, silk fibroin used in a silk optical film may be attained by extracting sericin from the cocoons of B. mori. Organic silkworm cocoons are also commercially available. There are many different silks, however, including spider silk (e.g., obtained from Nephila clavipes), transgenic silks, genetically engineered silks, such as silks from bacteria, yeast, mammalian cells, transgenic animals, or transgenic plants (see, e.g., WO 97/08315; U.S. Pat. No. 5,245,012), and variants thereof, that may be used.

In general, silk for use in accordance with the present invention may be produced by any such organism, or may be prepared through an artificial process, for example, involving genetic engineering of cells or organisms to produce a silk protein and/or chemical synthesis. In some embodiments of the present invention, silk is produced by the silkworm, Bombyx mori.

As is known in the art, silks are modular in design, with large internal repeats flanked by shorter (˜100 amino acid) terminal domains (N and C termini). Silks have high molecular weight (200 to 350 kDa or higher) with transcripts of 10,000 base pairs and higher and >3000 amino acids (reviewed in Omenatto and Kaplan (2010) Science 329: 528-531). The larger modular domains are interrupted with relatively short spacers with hydrophobic charge groups in the case of silkworm silk. N- and C-termini are involved in the assembly and processing of silks, including pH control of assembly. The N- and C-termini are highly conserved, in spite of their relatively small size compared with the internal modules.

Table 1, below, provides an exemplary list of silk-producing species and silk proteins:

TABLE 1
An exemplary list of silk-producing species and silk proteins
(adopted from Bini et al. (2003), J. Mol. Biol. 335(1): 27-40).

| | | Producing | |
|---|---|---|---|
| Accession | Species | gland | Protein |
| A. Silkworms | | | |
| AAN28165 | Antheraea mylitta | Salivary | Fibroin |
| AAC32606 | Antheraea pernyi | Salivary | Fibroin |
| AAK83145 | Antheraea yamamai | Salivary | Fibroin |
| AAG10393 | Galleria mellonella | Salivary | Heavy-chain fibroin |
| | | | (N-terminal) |
| AAG10394 | Galleria mellonella | Salivary | Heavy-chain fibroin |
| | | | (C-terminal) |
| P05790 | Bombyx mori | Salivary | Fibroin heavy chain |
| | | | precursor, Fib-H, |
| | | | H-fibroin |
| CAA27612 | Bombyx mandarina | Salivary | Fibroin |
| Q26427 | Galleria mellonella | Salivary | Fibroin light chain |
| | | | precursor, Fib-L, |
| | | | L-fibroin, PG-1 |
| P21828 | Bombyx mori | Salivary | Fibroin light chain |
| | | | precursor, Fib-L, |
| | | | L-fibroin |
| | | Producing | |
| | | Producing | |
| Accession | Species | gland | Protein |
| B. Spiders | | | |
| P19837 | Nephila clavipes | Major | Spidroin 1, |
| | | ampullate | dragline silk |
| | | | fibroin 1 |
| P46804 | Nephila clavipes | Major | Spidroin 2, |
| | | ampullate | dragline silk |
| | | | fibroin 2 |
| AAK30609 | Nephila senegalensis | Major | Spidroin 2 |
| | | ampullate | |
| AAK30601 | Gasteracantha | Major | Spidroin 2 |
| | mammosa | ampullate | |
| AAK30592 | Argiope aurantia | Major | Spidroin 2 |
| | | ampullate | |
| AAC47011 | Araneus diadematus | Major | Fibroin-4, ADF-4 |
| | | ampullate | |
| AAK30604 | Latrodectus | Major | Spidroin 2 |
| | geometricus | ampullate | |
| AAC04503 | Araneus | Major | Spidroin 2 |
| | bicentenarius | ampullate | |
| AAK30615 | Tetragnatha | Major | Spidroin 1 |
| | versicolor | ampullate | |
| AAN85280 | Araneus ventricosus | Major | Dragline silk |
| | | ampullate | protein-1 |
| AAN85281 | Araneus ventricosus | Major | Dragline silk |
| | | ampullate | protein-2 |
| AAC14589 | Nephila clavipes | Minor | MiSp1 silk protein |
| | | ampullate | |
| AAK30598 | Dolomedes | Ampullate | Fibroin 1 |
| | tenebrosus | | |
| AAK30599 | Dolomedes | Ampullate | Fibroin 2 |
| | tenebrosus | | |
| AAK30600 | Euagrus chisoseus | Combined | Fibroin 1 |
| AAK30610 | Plectreurys tristis | Larger ampule- | Fibroin 1 |
| | | shaped | |
| AAK30611 | Plectreurys tristis | Larger ampule- | Fibroin 2 |
| | | shaped | |
| AAK30612 | Plectreurys tristis | Larger ampule- | Fibroin 3 |
| | | shaped | |
| AAK30613 | Plectreurys tristis | Larger ampule- | Fibroin 4 |
| | | shaped | |
| AAK30593 | Argiope trifasciata | Flagelliform | Silk protein |
| AAF36091 | Nephila | Flagelliform | Fibroin, silk protein |
| | madagascariensis | | (N-terminal) |
| AAF36092 | Nephila | Flagelliform | Silk protein |
| | madagascariensis | | (C-terminal) |
| AAC38846 | Nephila clavipes | Flagelliform | Fibroin, silk protein |
| | | | (N-terminal) |
| AAC38847 | Nephila clavipes | Flagelliform | Silk protein |
| | | | (C-terminal) |

Thus, fibroin is a type of structural protein produced by certain spider and insect species that produce silk. Cocoon silk produced by the silkworm, Bombyx mori, is of particular interest because it offers low-cost, bulk-scale production suitable for a number of commercial applications, such as textile.

Silkworm cocoon silk contains two structural proteins, the fibroin heavy chain (˜350 k Da) and the fibroin light chain (˜25 k Da), which are associated with a family of non-structural proteins termed sericin, which glue the fibroin brins together in forming the cocoon. The heavy and light chains of fibroin are linked by a disulfide bond at the C-terminus of the two subunits (Takei, F., Kikuchi, Y., Kikuchi, A., Mizuno, S, and Shimura, K. (1987) J. Cell Biol., 105, 175-180; Tanaka, K., Mori, K. and Mizuno, S. (1993) J. Biochem. (Tokyo), 114, 1-4; Tanaka, K., Kajiyama, N., Ishikura, K., Waga, S., Kikuchi, A., Ohtomo, K., Takagi, T. and Mizuno, S. (1999) Biochim. Biophys. Acta, 1432, 92-103; Y Kikuchi, K Mori, S Suzuki, K Yamaguchi and S Mizuno, Structure of the Bombyx mori fibroin light-chain-encoding gene: upstream sequence elements common to the light and heavy chain, Gene 110 (1992), pp. 151-158). The sericins are a high molecular weight, soluble glycoprotein constituent of silk which gives the stickiness to the material. These glycoproteins are hydrophilic and can be easily removed from cocoons by boiling in water.

As used herein, the term “silk fibroin” refers to silk fibroin protein, whether produced by silkworm, spider, or other insect, or otherwise generated (Lucas et al., Adv. Protein Chem., 13: 107-242 (1958)). In some embodiments, silk fibroin is obtained from a solution containing a dissolved silkworm silk or spider silk. For example, in some embodiments, silkworm silk fibroins are obtained, from the cocoon of Bombyx mori. In some embodiments, spider silk fibroins are obtained, for example, from Nephila clavipes. In the alternative, in some embodiments, silk fibroins suitable for use in the invention are obtained from a solution containing a genetically engineered silk harvested from bacteria, yeast, mammalian cells, transgenic animals or transgenic plants. See, e.g., WO 97/08315 and U.S. Pat. No. 5,245,012, each of which is incorporated herein as reference in its entirety.

Thus, in some embodiments, a silk solution is used to fabricate compositions of the present invention contain fibroin proteins, essentially free of sericins. In some embodiments, silk solutions used to fabricate various compositions of the present invention contain the heavy chain of fibroin, but are essentially free of other proteins. In other embodiments, silk solutions used to fabricate various compositions of the present invention contain both the heavy and light chains of fibroin, but are essentially free of other proteins. In certain embodiments, silk solutions used to fabricate various compositions of the present invention comprise both a heavy and a light chain of silk fibroin; in some such embodiments, the heavy chain and the light chain of silk fibroin are linked via at least one disulfide bond. In some embodiments where the heavy and light chains of fibroin are present, they are linked via one, two, three or more disulfide bonds.

Although different species of silk-producing organisms, and different types of silk, have different amino acid compositions, various fibroin proteins share certain structural features. A general trend in silk fibroin structure is a sequence of amino acids that is characterized by usually alternating glycine and alanine, or alanine alone. Such configuration allows fibroin molecules to self-assemble into a beta-sheet conformation. These “Ala-rich” hydrophobic blocks are typically separated by segments of amino acids with bulky side-groups (e.g., hydrophilic spacers).

In some embodiments, core repeat sequences of the hydrophobic blocks of fibroin are represented by the following amino acid sequences and/or formulae: (GAGAGS)₅₋₁₅ (SEQ ID NO: 1); (GX)₅₋₁₅ (X=V, I, A) (SEQ ID NO: 2); GAAS (SEQ ID NO: 3); (S₁₋₂A₁₁₋₁₃) (SEQ ID NO: 4); GX₁₋₄ GGX (SEQ ID NO: 5); GGGX (X=A, S, Y, R, D V, W, R, D) (SEQ ID NO: 6); (S₁₋₂A₁₋₄)₁₋₂ (SEQ ID NO: 7); GLGGLG (SEQ ID NO: 8); GXGGXG (X=L, I, V, P) (SEQ ID NO: 9); GPX (X=L, Y, I); (GP(GGX)₁₋₄ Y)n (X=Y, V, S, A) (SEQ ID NO: 10); GRGGAn (SEQ ID NO: 11); GGXn (X=A, T, V, S); GAG(A)₆₋₇GGA (SEQ ID NO: 12); and GGX GX GXX (X=Q, Y, L, A, S, R) (SEQ ID NO: 13).

In some embodiments, a fibroin peptide contains multiple hydrophobic blocks, e.g., 3, 4, 5, 6, 7, 8, 9, 10, 11, 12, 13, 14, 15, 16, 17, 18, 19 and 20 hydrophobic blocks within the peptide. In some embodiments, a fibroin peptide contains between 4-17 hydrophobic blocks.

In some embodiments of the invention, a fibroin peptide comprises at least one hydrophilic spacer sequence (“hydrophilic block”) that is about 4-50 amino acids in length. Non-limiting examples of the hydrophilic spacer sequences include:

TGSSGFGPYVNGGYSG (SEQ ID NO: 14); YEYAWSSE (SEQ ID NO: 15); SDFGTGS (SEQ ID NO: 16); RRAGYDR (SEQ ID NO: 17); EVIVIDDR(SEQ ID NO: 18); TTIIEDLDITIDGADGPI (SEQ ID NO: 19) and TISEELTI (SEQ ID NO: 20).

In certain embodiments, a fibroin peptide contains a hydrophilic spacer sequence that is a derivative of any one of the representative spacer sequences listed above. Such derivatives are at least 75%, at least 80%, at least 85%, at least 90%, or at least 95% identical to any one of the hydrophilic spacer sequences.

In some embodiments, a fibroin peptide suitable for the present invention contains no spacer.

As noted, silks are fibrous proteins and are characterized by modular units linked together to form high molecular weight, highly repetitive proteins. These modular units or domains, each with specific amino acid sequences and chemistries, are thought to provide specific functions. For example, sequence motifs such as poly-alanine (polyA) and poly-alanine-glycine (poly-AG) are inclined to be beta-sheet-forming; GXX motifs contribute to 31-helix formation; GXG motifs provide stiffness; and, GPGXX (SEQ ID NO: 22) contributes to beta-spiral formation. These are examples of key components in various silk structures whose positioning and arrangement are intimately tied with the end material properties of silk-based materials (reviewed in Omenetto and Kaplan (2010) Science 329: 528-531).

It has been observed that the beta-sheets of fibroin proteins stack to form crystals, whereas the other segments form amorphous domains. It is the interplay between the hard crystalline segments, and the strained elastic semi amorphous regions, that gives silk its extraordinary properties. Non-limiting examples of repeat sequences and spacer sequences from various silk-producing species are provided in Table 2 below.

TABLE 2
Hydrophobic and hydrophilic components of fibroin sequences
(adopted from Bini et al. (2003), J. Mol. Biol. 335(1): 27-40).

| | Hydrophilic blocks | | | | | |
|---|---|---|---|---|---|---|
| | | | Hydrophilic | | | |
| | N- | C- | spacer (aa) | Hydrophobic blocks | | |
| | term | term | & representative | Range, | # of | Core repeat |
| Species | aa | aa | sequence | aa | Blocks | sequences |

A. Lepidoptera (Heavy chain fibroin)

| | | | | | | |
|---|---|---|---|---|---|---|
| Bombyx | 151 | 50 | 32-33, | 159-607 | 12 | (GAGAGS)₅₋₁₅, |
| mori | | | TGSSGFGPYVNGGYS | | | (SEQ ID NO: 1); |
| | | | G, | | | (GX)₅₋₁₅ (X = V, I, A), |
| | | | (SEQ ID NO: 14) | | | (SEQ ID NO: 2); |
| | | | | | | GAAS |
| | | | | | | (SEQ ID NO: 3) |
| Bombyx | 151 | | YEYAWSSE, | | | |
| mandarina | | | (SEQ ID NO: 15) | | | |
| Antheraea | 86 | | SDFGTGS, | | | |
| mylitta | | | (SEQ ID NO: 16) | | | |
| Antheraea | 87 | 32 | | | | |
| pernyi | | | | | | |
| Antheraea | 87 | 32 | 7, | 140-340 | 16 | (S₁₋₂A₁₁₋₁₃), |
| yamamai | | | RRAGYDR, | | | (SEQ ID NO: 4); |
| | | | (SEQ ID NO 17) | | | GX₁₋₄ GGX, |
| | | | | | | (SEQ ID NO: 5); |
| | | | | | | GGGX (X = A, S, Y, |
| | | | | | | R, D V, W, R, D), |
| | | | | | | (SEQ ID NO: 6) |
| Galleria | 189 | 60 | 6-8, | 75-99 | 13 | (S₁₋₂A₁₋₄)₁₋₂, |
| mellonella | | | EVIVIDDR, | | | (SEQ ID NO: 7); |
| | | | (SEQ ID NO: 18) | | | GLGGLG, |
| | | | | | | (SEQ ID NO: 8); |
| | | | | | | GXGGXG (X = L, I, V, P), |
| | | | | | | (SEQ ID NO: 9); |
| | | | | | | GPX (X = L, Y, I) |

B. Arachnida

| | | | | | | |
|---|---|---|---|---|---|---|
| Nephila | 115 | 89 | | | | |
| clavipes | | | | | | |
| Nephia | 115 | 89 | 26, | 260-380 | 5 | (GP(GGX)1-4 Y)n |
| madascariensis | | | TTIIEDLDITIDG | | | (X = Y, V, S, A), |
| | | | ADGPI, | | | (SEQ ID NO: 10) |
| | | | (SEQ ID NO: 19) | | | |
| Argiope | | 113 | | | | GRGGAn, |
| trifasciata | | | | | | (SEQ ID NO 11) |
| | | | | | | GGXn (X = A, T, V, S) |
| Major | | | TISEELTI, | | | |
| ampullata | | | (SEQ ID NO: 20) | | | |
| Nephila | | 97 | No spacer | 19-46 | | GAG(A)₆₋₇GGA, |
| clavipes | | | | | | (SEQ ID NO: 12); |
| | | | | | | GGX GX GXX(X = Q, Y, L, |
| | | | | | | A, S, R), |
| | | | | | | (SEQ ID NO: 13) |
| Gasteracantha | | 89 | No spacer | | | |
| mammosa | | | | | | |
| Argiope | | 82 | No spacer | | | |
| aurantia | | | | | | |
| Nephila | | 82 | No spacer | | | |
| senegalensis | | | | | | |
| Latrodectus | | 88 | No spacer | | | |
| geometricus | | | | | | |
| Araneus | | 94 | No spacer | | | |
| diadematus | | | | | | |

The complete sequence of the Bombyx mori fibroin gene has been determined (C.-Z Zhou, F Confalonieri, N Medina, Y Zivanovic, C Esnault and T Yang et al., Fine organization of Bombyx mori fibroin heavy chain gene, Nucl. Acids Res. 28 (2000), pp. 2413-2419). The fibroin coding sequence presents a spectacular organization, with a highly repetitive and G-rich (−45%) core flanked by non-repetitive 5′ and 3′ ends. This repetitive core is composed of alternate arrays of 12 repetitive and 11 amorphous domains. The sequences of the amorphous domains are evolutionarily conserved and the repetitive domains differ from each other in length by a variety of tandem repeats of subdomains of ˜208 bp.

The silkworm fibroin protein consists of layers of antiparallel beta sheets whose primary structure mainly consists of the recurrent amino acid sequence (Gly-Ser-Gly-Ala-Gly-Ala)n (SEQ ID NO: 21). The beta-sheet configuration of fibroin is largely responsible for the tensile strength of the material due to hydrogen bonds formed in these regions. In addition to being stronger than Kevlar, fibroin is known to be highly elastic. Historically, these attributes have made it a material with applications in several areas, including textile manufacture.

Fibroin is known to arrange itself in three structures at the macromolecular level, termed silk I, silk II, and silk III, the first two being the primary structures observed in nature. The silk II structure generally refers to the beta-sheet conformation of fibroin. Silk I, which is the other main crystal structure of silk fibroin, is a hydrated structure and is considered to be a necessary intermediate for the preorganization or prealignment of silk fibroin molecules. In the nature, silk I structure is transformed into silk II structure after spinning process. For example, silk I is the natural form of fibroin, as emitted from the Bombyx mori silk glands. Silk II refers to the arrangement of fibroin molecules in spun silk, which has greater strength and is often used commercially in various applications. As noted above, the amino-acid sequence of the β-sheet forming crystalline region of fibroin is dominated by the hydrophobic sequence. Silk fibre formation involves shear and elongational stress acting on the fibroin solution (up to 30% wt/vol.) in the gland, causing fibroin in solution to crystallize. The process involves a lyotropic liquid crystal phase, which is transformed from a gel to a sol state during spinning—that is, a liquid crystal spinning process 1. Elongational flow orients the fibroin chains, and the liquid is converted into filaments.

Silk III is a newly discovered structure of fibroin (Valluzzi, Regina; Gido, Samuel P.; Muller, Wayne; Kaplan, David L. (1999). “Orientation of silk III at the air-water interface”. International Journal of Biological Macromolecules 24: 237-242). Silk III is formed principally in solutions of fibroin at an interface (i.e. air-water interface, water-oil interface, etc.).

Silk can assemble, and in fact can self-assemble, into crystalline structures. Silk fibroin can be fabricated into desired shapes and conformations, such as silk hydrogels (WO2005/012606; PCT/US08/65076), ultrathin films (WO2007/016524), thick films, conformal coatings (WO2005/000483; WO2005/123114), foams (WO 2005/012606), electrospun mats (WO 2004/000915), microspheres (PCT/US2007/020789), 3D porous matrices (WO2004/062697), solid blocks (WO2003/056297), microfluidic devices (PCT/US07/83646; PCT/US07/83634), electro-optical devices (PCT/US07/83639), and fibers with diameters ranging from the nanoscale (WO2004/000915) to several centimeters (U.S. Pat. No. 6,902,932). The above mentioned applications and patents are incorporated herein by reference in their entirety. For example, silk fibroin can be processed into thin, mechanically robust films with excellent surface quality and optical transparency, which provides an ideal substrate acting as a mechanical support for high-technology materials, such as thin metal layers and contacts, semiconductor films, dielectic powders, nanoparticles, and the like.

As described herein, silk particle compositions useful for the present invention are typically prepared from silk films. In some embodiments, utilized films are characterized by having certain optical properties.

Unique physiochemical properties of silk allows its use in a variety of applications. For example, silk is stable, flexible, durable and biocompatible. Biocompatibility broadly refers to silk's safe and non-toxic nature, including being biodegradable, edible, implantable and non-antigenic (e.g., does not cause irritation or induce immune response). Furthermore, useful silk materials can be prepared through processes that can be carried out at room temperature and are water-based.

Surface Properties of Silk-Based Materials

In addition, silk-based materials can be prepared in accordance with the present invention to be smooth and/or adhesive at the molecular level. In some embodiments, silk-based materials provided by and/or utilized in accordance with the present invention are smooth at the molecular level. Silk-based materials showing molecular level smoothness permit certain applications that are not possible with other materials.

It should be appreciated that not all silk-based compositions necessarily have the surface properties described herein (e.g., an extraordinary high degree of smoothness) that are particularly desirable for optical devices. For example, prior to the present invention and its appreciation of certain desirable properties the typical surface roughness of available silk materials was commonly in the range of approximately 10 nm and greater. While this is significantly more “smooth” as compared to other widely used matrix materials, such as PDMS, nano-scale applications for purposes of supporting a non-biological structures composed of conductive materials such as metal, in particular, posed a technical challenge.

As provided in the Example sections below, the present inventors have developed fabrication methods to produce silk matrices of superior surface qualities and malleability (e.g., flexibility) suitable for a manipulation directed to optical devices. In some embodiments, silk matrices prepared according to the methods described herein are characterized by having the surface roughness of less than about 5 nm. In some embodiments, silk matrices suitable for the present invention have the surface roughness of less than about 4.0 nm, about 3.5 nm, about 3.0 nm, about 2.5 nm, about 2.0 nm, about 1.5 nm, or about 1 nm.

Electrogelation (“e-gel”)-based silk matrices exhibit extraordinary smooth surface morphology. As determined by atomic force microscopy (AFM), silk materials prepared by electrogelation may have a surface that is around 1 nm in surface roughness. Such property allows the silk matrix to be etched or manipulated with a nano-scale resolution.

In some embodiments of the present invention, for example when a silk-based material is prepared by methods described herein, silk fibroin assumes a predominantly beta-sheet conformation. As already noted, this configuration is believed to be responsible for the strength and elasticity of silk material. It is now recognized by the inventors of the present invention that the beta-sheet configuration also provides extraordinary surface smoothness of silk materials, including silk film.

The present inventors have now discovered that silk-based materials can be used to provide an extraordinary smooth surface at the nano- and micro-scale which can be used to coat a wide range of objects and/or be dispersed in a variety of media. As described in more detail below, the compositions and methods described herein can offer safe and cost-effective applications in a number of areas, including but not limited to food industry, cosmetic applications, medical applications, consumer products, etc.

Degradation Properties of Silk-Based Materials

Additionally, as will be appreciated by those of skill in the art, much work has established that researchers have the ability to control the degradation process of silk. According to the present invention, such control can be particularly valuable in the fabrication of optical devices. Degradability (e.g., bio-degradability) is often desirable for biomaterials used in cosmetic applications, tissue engineering and implantation. The present invention encompasses the recognition that such degradability is also relevant to and useful in the fabrication of optical devices.

According to the present invention, one particularly desirable feature of silk-based materials is the fact that they can be programmably degradable. That is, as is known in the art, depending on how a particular silk-based material is prepared, it can be controlled to degrade at certain rates. Degradability and controlled release of a substance from silk-based materials have been published; see, for example, WO 2004/080346, WO 2005/012606, WO 2005/123114, WO 2007/016524, WO 2008/150861, WO 2008/118133, each of which is incorporated by reference herein.

Control of silk material production methods as well as various forms of silk-based materials can generate silk compositions with known degradataion properties. For example, using various silk fibroin materials (e.g., microspheres of approximately 2 μm in diameter, silk film, silk hydrogels) entrapped agents such as therapeutics can be loaded in active form, which is then released in a controlled fashion, e.g., over the course of minutes, hours, days, weeks to months. It has been shown that layered silk fibroin coatings can be used to coat substrates of any material, shape and size, which then can be used to entrap molecules for controlled release, e.g., 2-90 days.

In some embodiments, the degradation lifetime of the optical devices of the present disclosure can be controlled during the manufacturing process, for example, by controlling the ratio and amount of the silk fibroin solution cast. In some embodiments, the dissolution time of the silk film can be tuned from days to months by controlling the degree of crystallinity during the fibroin protein self-assembly process. Jin et al., 15 Adv. Funct. Mater. 1241 (2005); Lu et al., 6 Acta Biomater. 1380 (2010). This can be accomplished by regulating the water content within the silk film through an annealing step to stabilize the device for prolonged operation in wet environments such as those encountered in the in vitro and/or in vivo studies.

As stated, a solid-state silk fibroin or silk matrix (e.g., silk film) can be in any material format, such as silk fibers, electrospun fibers, films, mats, 3-D scaffolds, dried gels, spheres, or composites of one or more different formats of silk materials, as described herein. In one embodiment, the solid-state silk fibroin is a silk film.

Crystalline Silk Materials

As known in the art and as described herein, silk proteins can stack with one another in crystalline arrays. Various properties of such arrays are determined, for example, by the degree of beta-sheet structure in the material, the degree of cross-linking between such beta sheets, the presence (or absence) of certain dopants or other materials.

In many embodiments, one or more of these features is intentionally controlled or engineered to achieve particular characteristics of a silk matrix.

In many embodiments, the present invention utilizes a crystalline silk material (e.g., not an amorphous material).

Is some embodiments, crystalline silk materials for use in accordance with the present invention are characterized by having smooth surface morphology, adhesive to conductive materials such as metal, and conforms to biological materials.

As noted herein, crystalline silk materials can show unusual surface smoothness. According to the present invention, silk materials showing surface smoothness within the range of, for example, about 1 nm to 10 nm, are particularly useful in the fabrication of optical devices as described herein.

Particle Composition Characteristics

One aspect of the invention provides compositions and methods for preparing a particle composition comprising silk optical particles having at least one optical property. As described further below, examples of optical properties include, but are not limited to: reflectivity, diffraction, refraction, absorption, optical gain, fluorescence, iridescence, and light scattering.

Overview Of Optical Properties of Optical Devices Formed on Silk Films

In some embodiments, the optical property exhibited by an optical device on a silk film can be reflectivity, retro-reflectivity, diffraction, refraction, absorption, optical gain, fluorescence, and/or light scattering, although optical devices can exhibit other optical properties. Some optical devices can exhibit more than one optical property.

Examples Of Optical Devices

An optical device can be a structure with a user-designed response to light. In some embodiments, an optical device is or comprises a lens, lens array, microlens array, optical grating, pattern generator, beam reshaper, diffraction grating, optofluidic devices, beam homogenizers, photonic crystals, waveguides, 1-D or 2-D gratings, prisms, and/or microprisms array. In some embodiments, an optical device is or comprises a reflective element. Exemplary reflective elements include minors (e.g., flat mirrors), reflectors (e.g., diamond-cut reflectors), and retroreflectors (retroreflectors with various geometries, such as corner-cube, hemispherical, and/or “cat's-eye” geometries). Exemplary reflective elements include mirror-backed lens and retro-reflecting cavities containing orthogonal intersecting planes (e.g., corners of square, rectangular, or cubical cavities). An optical device can be a device known in the fields of diffractive optics, micro-optics, photonics, and/or guided wave optics

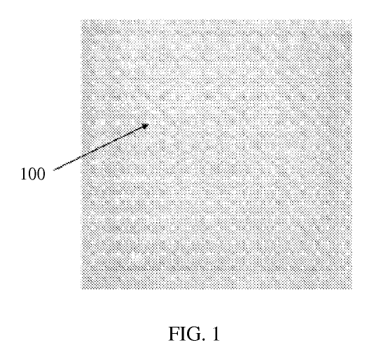

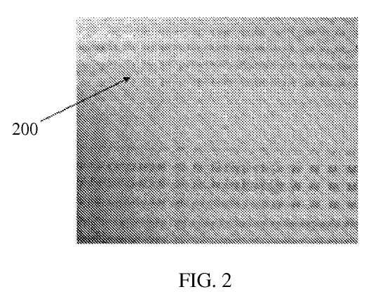

In some embodiments, optical devices on a silk film can include an array of lenses. FIGS. 1 and 2 depict exemplary silk films with arrays of lenses 100, 200. In some embodiments, each lens in the array can be approximately 1 cm² in diameter, although lenses with smaller diameters can be used.

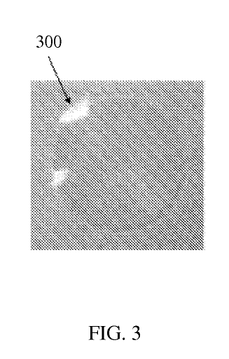

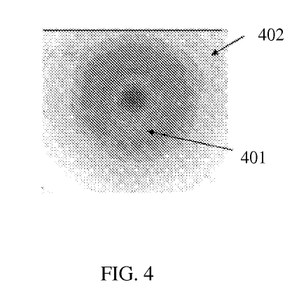

In some embodiments, an optical device 300 on a silk film can be a focusing lens with a diameter less than 1 cm, such as the lens depicts in FIG. 3. In some embodiments, the focusing lens can have patterned concentric rings 401, 402 formed on its surface, such as the lens depicted in FIG. 4.

In some embodiments, an optical device on a silk film can be a diffraction grating. In some embodiments, the diffraction gratings can be holographic. In some embodiments, the diffraction grating can be as large as 50×50 mm, although other sizes can be used. Diffraction gratings with any line pitch can be used. Exemplary line pitches include 300 lines/mm; 600 lines/mm; 1,000 lines/mm; 1,200 lines/mm; and 3,600 lines/mm.

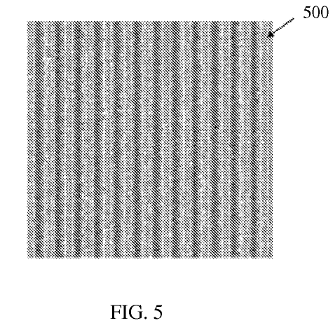

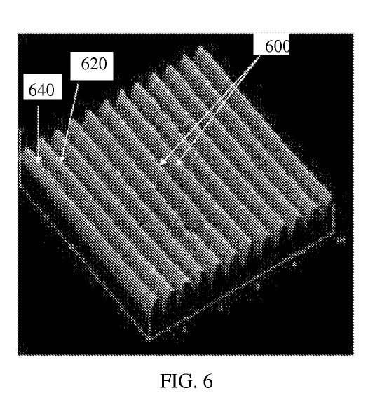

FIGS. 5 and 6 depict silk films with diffraction gratings. The diffraction grating 500 of the silk film in FIG. 5 has a pitch of about 2,400 lines/mm. The ridges 600, 620, 640 of the diffraction grating of FIG. 6 are approximately 200 nm wide at full width at half maximum (FWHM). Diffraction gratings can have peak to valley height differences of any size. In some embodiments, the height difference can be about 150 nm. In some embodiments, the height difference can be about 60 nm.

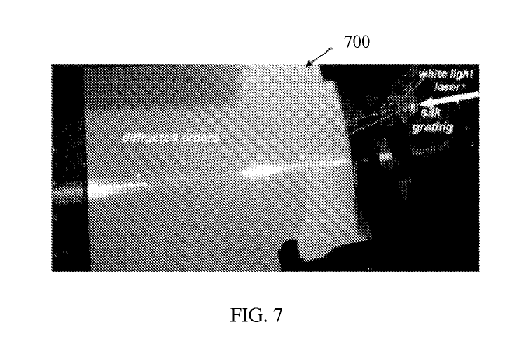

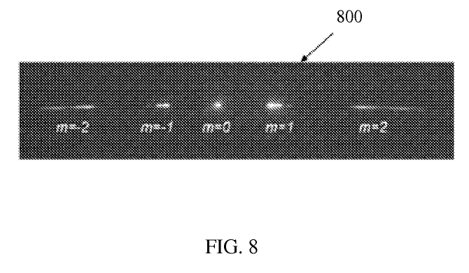

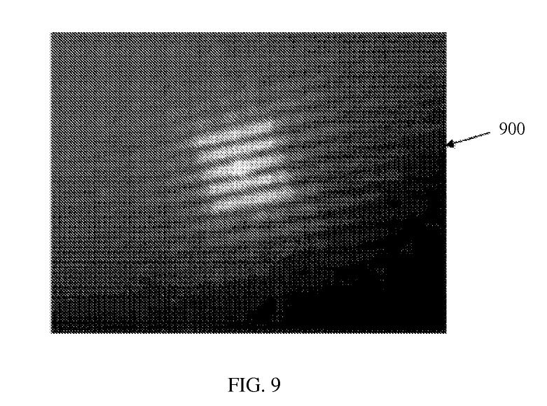

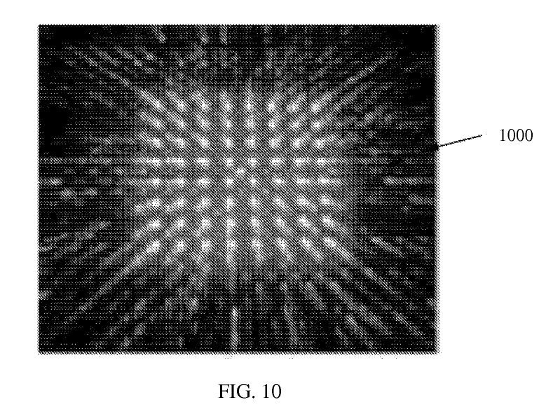

FIG. 7 depicts diffracted orders 700 from a white light laser source impinging on an exemplary silk film with a diffraction grating. In some embodiments, the diffracted orders include a central order and three diffraction orders. In some embodiments, the measured diffraction efficiency in the m=1 and m=−1 orders can be approximately 37%. FIG. 8 depicts diffracted orders 800 from a supercontinuum laser source impinging on a silk filk with a diffraction grating with a pitch of 1,200 lines/mm. The diffracted orders can be imaged 2 cm from the silk diffraction grating. The diffraction efficiency of this grating can be about 34% in the first order at 633 nm. FIGS. 9 and 10 depict exemplary patterns 900 and 100 of light transmitted through other silk films with diffractive gratings.

In some embodiments, a silk film with optical devices thereon can operate as a photonic crystal. In some embodiments, a photonic crystal can be a periodic dielectric or metallo-di electric structure that defines allowed and forbidden electronic energy bands. Such photonic crystals can affect the propagation of electromagnetic (EM) waves in the same manner in which the periodic potential in a semiconductor crystal affects electron motion.

In some embodiments, photonic crystals can include periodically repeating internal regions of high and low dielectric constants. Without wishing to be bound by theory, photons can propagate through the structure based upon the wavelength of the photons. Photons with wavelengths of light that are allowed to propagate through the structure are called “modes”. Photons with wavelengths of light that are not allowed to propagate are called “photonic band gaps”. The structure of the photonic crystals can define allowed and forbidden electronic energy bands. The photonic band gap can be characterized by the absence of propagating EM modes inside the structures in a range of wavelengths and can be either a full photonic band gap or a partial photonic band gap, and can give rise to distinct optical phenomena such as inhibition or enhancement of spontaneous emission, spectral selectivity of light, and/or spatial selectivity of light. Such structures can be used for high-reflecting omnidirectional mirrors and low-loss waveguides.

Without wishing to be bound by theory, in some embodiments, photonic crystals can be artificial dielectrics in which the refractive index is modulated over length scales comparable to the wavelength of light. These structures can behave as semiconductor crystals for light waves. In periodic structures, the interference can be constructive in well-defined propagation directions, leading to Bragg scattering and light refraction. At high enough refractive index contrast, light propagation can be prohibited in any direction within a characteristic range of frequencies. In some embodiments, because the physics of photonic crystals relies on Bragg scattering, the periodicity of the lattices can be commensurate with the wavelength of light. The choice of the building-block materials (i.e., the refractive index contrast) and lattice type (lattice symmetries, spatial frequencies) can affect the spectral selectivity and light-transport/scattering properties of photonic crystals. In some embodiments, the refractive index contrast (e.g., the relative difference in refractive index of the core transport medium and the cladding medium), can be used to create optical properties for optical devices, such as bright opalescence, coherent multiple scattering, light localization, and/or formation of complete photonic band gaps. In some embodiments, lattices exhibiting more random patterns can result in a more uniform distribution of light.

In some embodiments, the geometry of a pattern on a silk film can be based on a periodic photonic lattice, a non-periodic photonic lattice, or a combination of lattices. In some embodiments, the pattern can display optical activity in the form of opalescence. In some embodiments, the pattern can correspond to a nano-textured sub-wavelength structure.

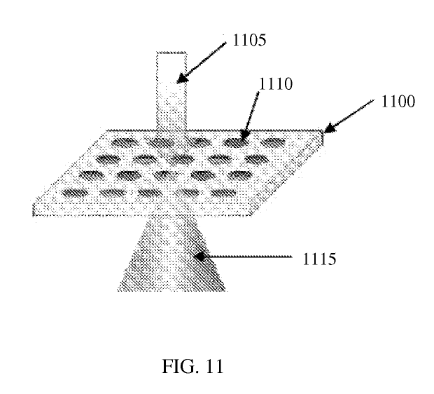

FIG. 11 depicts a patterned silk film 1100 that functions as a photonic bandgap. The silk film selects light 1105 according to the pattern structure 1110 provided on its surface and includes an air/dielectric structure with periodicity on the order of the wavelength. Light selectivity can be schematically shown by spectrum 1115 generated upon application of white light upon the silk film.

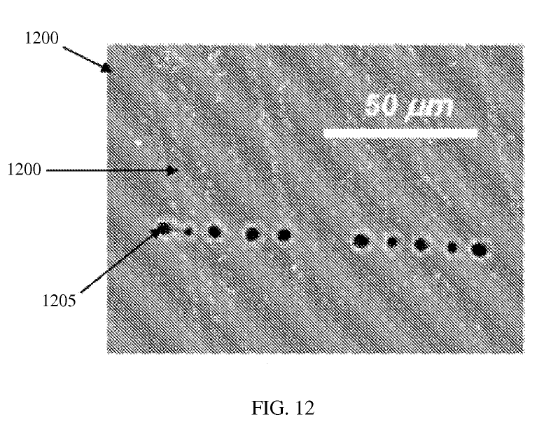

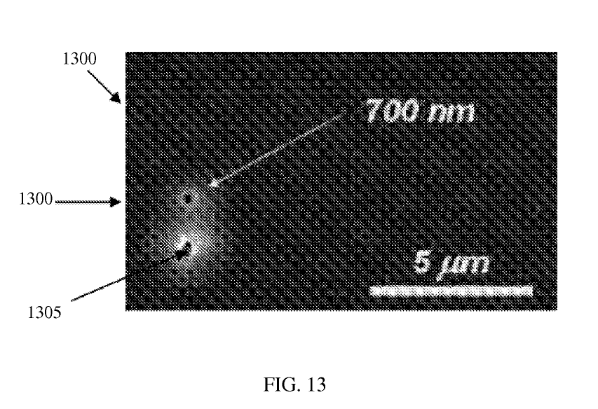

FIG. 12 depicts a portion of a patterned silk film 1200 on which a regular array of holes has been machined. These holes 1205 were machined by laser ablation using 810 nm femtosecond laser pulses. FIG. 13 depicts a portion of another patterned silk film 1300 on which an array of holes 1305 has been machined thereon, these holes being as small as 700 nm. Different sized holed can be obtained using different focusing conditions. In some embodiments, such machining can achieve sub-diffraction limit spot size patterning. In some embodiments, holes can be spaced between 50 nm-500 nm apart.

In some embodiments, the holes can be formed as deterministic aperiodic arrays. The arrays can be characterized by long-range order without translational invariance. In some embodiments, the arrays can be non-periodic but deterministic (regular/ordered). Photonic crystals created from one or more silk films with these arrays can display large photonic band-gaps and/or localized light states.

In some embodiments, holes and/or pits in the silk film can be ordered according to a lattice. Exemplary lattices include periodic lattices, Fibonacci quasi-periodic lattices, Thue-Morse (TM) aperiodic lattices, Rudin-Shapiro (RS) aperiodic lattices, random lattices, and other deterministic aperiodic lattices based on number theoretic sequences.

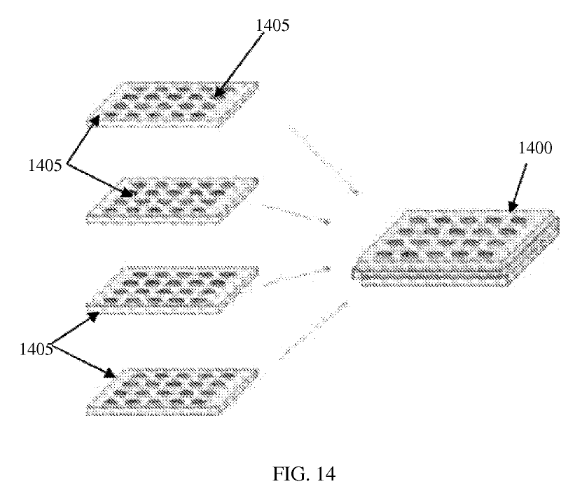

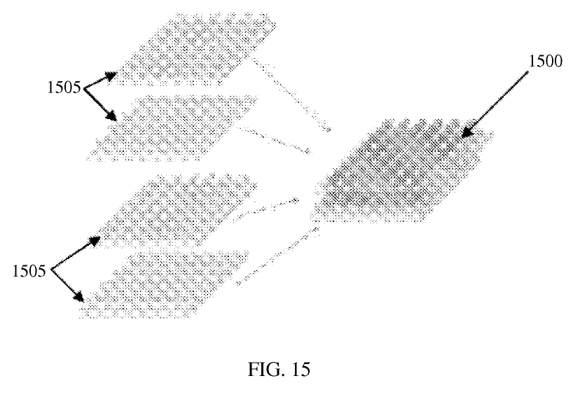

In some embodiments, patterned silk films can be stacked together to form a photonic crystal. In some embodiments, each silk film can have the same pattern. In some embodiments, some of the silk films within the stack can have different patterns. The different patterns can exhibit different optical properties. In some embodiments, silk films with different patterns can be chosen and stacked to produce a photonic crystal with desired optical properties. In some embodiments, adjacent films in the stack can be oriented to have different orientations from one another (e.g., 90 degree rotation between adjacent films). The patterns for the silk films, the number of silk films in the stack, and/or the orientation of the silk films within the stack can be chosen to produce a customized photonic crystal with desired optical properties. In some embodiments, the films can be bound together. FIGS. 14 and 15 depict exemplary photonic crystals 1400, 1500 formed by stacking patterned silk films 1405, 1505. In FIG. 14, the optical devices on the silk films are patterned. In FIG. 15, the optical devices on the silk films are holographic diffraction gratings.

In some embodiments, the optical devices on a silk film can, individually and/or in combination, form a reflector. In some embodiments, the optical devices can be reflective elements. Reflective elements can be patterned on a surface of a silk film. An array of reflective elements can be patterned on a surface of a silk film. In some embodiments, reflective particles can be dispersed in the silk film. The reflective particles can be dispersed through the entire film. The reflective particles can be dispersed on a surface of the silk film. In some embodiments, the reflective particles can be metal nanoparticles. In some embodiments, the reflective particles can include gold, silver, any other reflective metal, or combinations thereof.

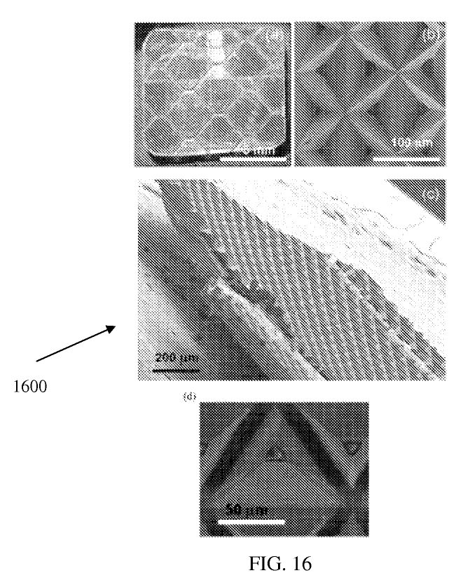

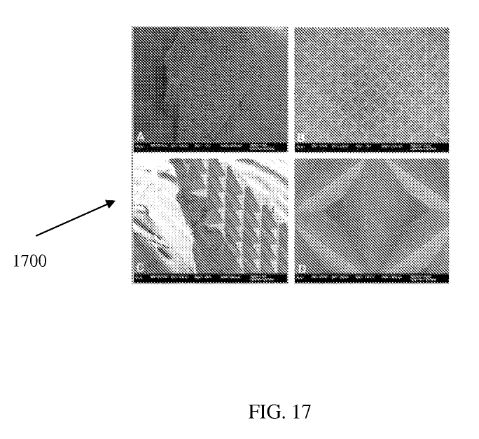

In some embodiments, the optical devices on a silk film can be microprisms. In some embodiments, the microprisms can be arranged in arrays. In some embodiments, the microprisms can have dimensions of about 100 μm and be clustered in groups, as shown in FIGS. 16 and 17. In some embodiments, the microprisms on the silk film can operate as reflectors. In some embodiments, the microprisms on the silk film can operate as retro-reflectors. In some embodiments, millimeter-sized microprism arrays on a silk film can rotate the image plane of an imaged subject.

In some embodiments, two or more silk films with optical devices can be stacked to form a silk reflector. The operation of the optical devices of the two or more silk films can determine the spectral response of the silk films. In some embodiments, different optical devices can be formed on different silk films in the stack. The silk films can have different indices of refraction from one another. The silk films can have different thicknesses from one another. The reflectivity of the silk films can be modulated by, for example, the number of silk films, the thickness of each silk film, the index of refraction of each silk film, the agents embedding in each silk film, surface modifications of each silk film by different functional groups (e.g., chemical functionalization, generic modification), conformation change of each silk film, progressive dissolution of each silk film, any other factor, or any other combination thereof. The reflectivity of the silk films can be modulated by, for example, partial dissolution of the silk film, addition of an active agent to the silk film, and/or functionalization of the silk film with an active group.

In some embodiments, the optical devices can be retroreflectors. Retroflectors can include microprism arrays. In some embodiments, microprisms can be on the order of millimeters.

In some embodiments, the optical devices present enhanced reflectivity and/or sensitivity at specific wavelengths. For example, the optical devices can filter incident light for a specific wavelength, e.g., a wavelength in the visible spectrum.

In some embodiments, silk reflectors can enhance reflectivity of one or more wavelengths when integrated into and operating within an irregular scattering and/or absorbing medium, such as a humid or wet scattering environments. This irregular scattering and/or absorbing medium can include any possible scattering medium known to one skilled in the art that the silk reflector may be useful in. For example, the scattering medium can be an ambient environment, humid or wet environment, water, liquids, suspensions or gels, biological environment such as inside a biological body where the scattering medium may be a biological tissue or organ. Without resorting to coherent detection techniques or any contrast agents for enhancement, the reflectivity of the silk reflector in these media can possess enhanced reflectivity to about 10-300%, for instance, at least about 20%, at least about 40%, at least about 100%, at least about 150%, at least about 200%, or at least about 250%. The reflectivity of the silk reflector in these media can therefore still be detected, with enhanced sensitivity, when the thickness of the scattering medium that blocks the detection source from the silk reflector is in the order of −0.1 mm, ˜1 mm, ˜1 cm, and −10 cm.

Reflective Particles

Reflective particles can create highlights that are visible to the naked eye.

Reflective particles may have various forms. Said particles may be in the form of platelets or globules, in particular spherical. Said particles may comprise a substrate covered with a reflective material.

The substrate may be selected from glasses, metal oxides, aluminas, silicas, silicates, especially aluminosilicates and borosilicates, mica, synthetic mica, synthetic polymers, and mixtures thereof.

The reflective material may comprise a layer of metal or a metallic compound.

Particles of glass substrate coated with silver, in the form of platelets, are sold under the trade name METASHINE by Nippon Sheet Glass.

Examples of reflective particles that may be mentioned are particles comprising a substrate of synthetic mica coated with titanium dioxide or particles of glass coated with brown iron oxide, titanium oxide, tin oxide or a mixture thereof, such as those sold under the trade name REFLECKS® by ENGELHARD. Pigments that are suitable for use in the invention are those from the METASHINE 1080R range sold by NIPPON SHEET GLASS CO. LTD. These pigments, more particularly those described in Japanese patent application JP-A-2001-11340, are C-GLASS glass flakes comprising 65% to 72% Siθ2 covered with a rutile (TiO₂) type titanium oxide layer. Said glass flakes have a mean thickness of 1 μm and a mean size of 80 μms, giving a mean size/thickness ratio of 80. They have blue, green or yellow glints or silver tints, depending on the thickness of the Tiθ2 layer. Particles with a dimension in the range 80 μm to 100 μm may also be mentioned, comprising a substrate of synthetic mica (fluorophlogopite) coated with titanium dioxide representing 12% of the total weight of the particle, sold under the trade name PROMINENCE by NIHON KOKEN. The reflective particles may also be selected from particles formed by a stack of at least two layers with different refractive indices. Said layers may be polymeric or metallic in nature and in particular may include at least one polymeric layer. The reflective particles may be particles deriving from a multilayered polymeric film. Said particles have in particular been described in WO-A-99/36477, U.S. Pat. No. 6,299,979 and U.S. Pat. No. 6,387,498. Reflective particles comprising a stack of at least two layers of polymers are sold by 3M under the trade name MIRROR GLITTER. Said particles comprise layers of 2,6-PEN and polymethylmethacrylate in a ratio by weight of 80/20. Such particles are described in patent document U.S. Pat. No. 5,825,643.

Goniochromatic or Iridescent Agents

In some embodiments, silk particle compositions described herein are iridescent. Iridescence is an optical phenomenon of surfaces in which hue changes in correspondence with the angle from which a surface is viewed. Iridescence is often caused by multiple reflections from two or more semi-transparent surfaces in which phase shift and interference of the reflections modulates the incidental light (by amplifying or attenuating some frequencies more than others). This process, termed thin-film interference, is the functional analog of selective wavelength attenuation as seen with the Fabry-Pérot interferometer. Iridescence may be a desirable optical feature for certain applications, such as cosmetic products, and general consumer articles such as toys for providing improved appearance.

Particle composition of the present invention comprising silk optical particles may be used in addition to or in lieu of a number of goniochromatic coloring agents typically used in prior art, which exhibit a color change, also termed a “color flop”, as a function of the angle of observation, which change is greater than that which occurs with nacres.

Thus, compositions provides herein may be safer and more cost-effective alternative to existing goniochromatic coloring agents and may replace, without limitation, any one of the following: CHROMAFLAIR by FLEX; SICOPEARL by BASF; XIRONA pigments by MERCK (Darmstadt) and INFINITE COLORS pigments from SHISEIDO or COLOR RELIEF pigments from CCIC.

Additionally or alternatively, silk optical compositions described herein may be used in addition to or in lieu of any one of the following examples of pigments and liquid crystal coloring agents: those sold by 3M under the trade name COLOR GLITTER or those sold by Venture Chemical under the trade name Micro Glitter Pearl; silicones or cellulose ethers onto which mesomorphous groups are grafted; those sold by CHENIX and that sold under the trade name HELICONE® HC by SICPA.

Silk particles with optical properties may be supplied as aerosol, which can be splayed or misted upon desired surfaces, including food. In addition, silk particles with optical properties may be incorporated into skin lotions, creams, foundations, perfumes, nail polishes, hair sprays, toothpastes, etc. In any of these applications, silk particle compositions may also include one or more additives such as flavorings, colorings, scents, etc.

In some embodiments, a particle composition comprises silk particles that are essentially uniform, e.g., silk particles in a particle composition are of uniform size, function, material, etc. In some embodiments, a particle composition comprises silk particles of different sorts. For example, a particle composition may comprise silk particles of varying size, function, material, etc. Thus, a particle composition may comprise silk particles having more than one optic properties. In some embodiments, a single silk particle has multiple optical properties. In some embodiments, a particle composition is a mixture of silk particles having discrete optical properties. As an example, a cosmetic product may contain silk particles that absorb certain UV light, in addition to silk particles that provide iridescence or any other desirable optical features. In some embodiments, a single silk particle may have more than one optical properties suitable for a particular use or product.

Particle Production

As mentioned above, the present invention includes methods of preparing silk optical particle compositions, e.g., powders, etc, as well as product comprising such composition for use in various applications. In one aspect, provided compositions include silk particles having (e.g., selected and/or designed to contain) at least one optical property, e.g., reflectivity, diffraction, refraction, absorption, optical gain fluorescence, and light scattering. The particular silk materials explicitly exemplified herein were typically prepared from material spun by silkworm, B. Mori. Typically, cocoons are boiled for ˜30 min in an aqueous solution of 0.02M Na₂CO₃, then rinsed thoroughly with water to extract the glue-like sericin proteins. The extracted silk is then dissolved in LiBr (such as 9.3 M) solution at room temperature, yielding a 20% (wt.) solution. The resulting silk fibroin solution can then be further processed for a variety of applications as described elsewhere herein. Those of ordinary skill in the art understand other sources available and may well be appropriate, such as those exemplified in the Table above.

Once a solid-state silk (such as silk film) is obtained, it can be further processed to provide desired optical properties, such as reflective properties, diffractive properties, and photonic properties by manipulating the surface of the film. This can be carried out by processes known in the art.

The silk film can be prepared by depositing an aqueous silk fibroin-containing solution on a support substrate and allowing the silk fibroin solution to dry into a film. In this regard, the substrate coated with silk fibroin-based solution may be exposed in air for a period of time, such as 12 hours. Depositing the silk fibroin solution can be performed by, e.g., using a spin coating method, where the silk fibroin solution is spin coated onto the substrate to allow the fabrication of thin membranes of non-uniform in height; or simply by pouring silk fibroin solution over the top of the substrate. The properties of the silk fibroin film, such as thickness and content of other components, as well as optical features, may be altered based on the concentration and/or the volume of the silk fibroin solution applied to the substrate, and the techniques used for processing the silk fibroin solution into silk film. For instance, the thickness of the silk film may be controlled by changing the concentration of the silk fibroin in the solution, or by using desired volumes of silk fibroin solution, resulting silk fibroin film with a thickness ranging from approximately 2 nm to 1 mm thick. In one embodiment, one can spin coat the silk fibroin onto a substrate to create films having thickness from about 2 nm to about 100 μm using various concentrations of silk fibroin and spinning speeds. The silk fibroin films formed herein have excellent surface quality and optical transparency.

The aqueous silk fibroin solution used for making a solid-state silk fibroin can be prepared using techniques known in the art. Suitable processes for preparing silk fibroin solution are disclosed, for example, in U.S. patent application Ser. No. 11/247,358; WO/2005/012606; and WO/2008/127401. The silk aqueous solution can then be processed into silk matrix such as silk films, conformal coatings or layers, or 3-dimensional scaffolds, or electrospun fibers for further processing into the silk reflectors. A micro-filtration step may be used herein. For example, the prepared silk fibroin solution may be processed further by centrifugation and syringe based micro-filtration before further processing into silk matrix. This process enables the production of silk fibroin solution of excellent optical quality and stability. The micro-filtration step is often desirable for the generation of high-quality optical films with minimized scattering.

In some embodiments, a silk film is produced to have micro- or nano-patterning on at least one surface of the film. Typically, such patterning on silk film is produced on one surface of the silk film. Such silk film has certain optical properties, depending on the patterning generated. Upon further processing of a silk film having optical properties to generate a silk particle composition compositing silk particles of for example micro- or nano-scale, such composition retains certain optical properties that were embedded or etched onto the film used to generate the particle composition. Thus, silk particles described herein can be used for certain applications for which other forms of silk, such as silk film, cannot be used. Silk particles can be dispersed and incorporated into compositions that are water-based, lipid-based, etc., while maintaining the optical functionality of silk optic components.

Fabrication of Optical Devices on Silk Films

Optical devices can be fabricated on silk matrices with patterning techniques that can avoid prolonged times of sample preparation, elevated temperature, and/or high vacuums. Such patterning techniques can be inexpensive. Some pattern techniques can be performed at ambient temperature and pressure conditions, thereby preserving the functionality of biological dopants in silk matrices. Exemplary temperatures include 40° C. or lower. Exemplary pressures include 700-800 mTorr. Another exemplary pressure is 760 mTorr.

In some embodiments, optical devices can be fabricated on silk films with exceptional levels of smoothness. Silk films can exhibit smoothness that is less than about 10 nm, 9 nm, 8 nm, 7 nm, 6 nm, 5 nm, 4 nm, 3 nm, 2 nm or about 1 nm. In some embodiments, the localized surface roughness of the silk film can be less than about 20 nm or less than about 10 nm. In some embodiments, the roughness of the silk film can have root-mean-squared roughness values between 2.5 and 5 nm. In some embodiments, the surface roughness can be less than λ/50, when λ=633 nm. In some embodiments, the features of the optical devices can exhibit surface smoothness while being structurally stable.

In some embodiments, the silk film can have non-uniform thickness. For example, the thickness of the film can range from less than about 10 μm to about 200-999 μm.

In some embodiments, optical devices can be fabricated on a silk film by conforming the silk firm to a pattern on a substrate, by way of example. The pattern can correspond to an optical device. The geometry of the pattern can correspond to the optical properties of the optical device. The geometry of the pattern can determine the spectral response of the optical device.

In some embodiments, a pattern for an optical device can include structural features whose sizes can be approximately measured on a nanometer scale (that is, 10⁻⁹ meters). In some examples, sizes can range from less than about 20 nm to a few microns, e.g. 5 μm. In some embodiments, an optical device can be about 75 nm. In some embodiments, an optical device can be about 100 nm. In some embodiments, an optical device can have one or more features with dimensions of about 210 nm. In some embodiments, an optical device can have features as small as 700 nm that are spaced less than 3 μm. In some embodiments, structural features of a pattern for an optical device can be approximately measured on a millimeter or micrometer scale.

In some embodiments, optical devices can be formed on silk films by casting a silk fibroin solution onto a patterned substrate. A silk fibroin solution can be prepared. In some embodiments, the silk fibroin solution can be acqueous, although other solvents can be used. An aqueous silk fibroin solution can be between approximately 1.0 wt % and 30 wt % silk. In some embodiments, the solution can be approximately 8.0 wt % silk. Different percent weight solutions can be used to optimize flexibility and/or strength of the silk film while maintaining desired optical functions. Exemplary production of aqueous silk fibroin solution is described in detail in WIPO Publication Number WO 2005/012606 entitled “Concentrated Aqueous Silk Fibroin Solution and Uses Thereof. In some embodiments, a micro-filtration step can be used. For example, the silk fibroin solution can be processed by centrifugation and syringe based micro-filtration. The processes can improve the optical quality and stability of silk films formed from the solution.

A patterned substrate can serve as a mold and/or template in fabricating the silk film with optical devices. Various substances can be chosen for the substrate, such as a polycarbonate film from Digital Optics Corporation or a microprism master mould (3M™ SCOTCHLITE™ Reflective Material—High Gloss Film, 3M, St. Paul, Minn.). In some embodiments, the substrate can be an elastomeric stamp or a composite elastomeric stamp. In some embodiments, the substrate can be a glass plate coated with polyimide-poly(methylmethacrylate) (PMMA). In some embodiments, the substrate can include teflon. In some embodiments, the substrate can include a hydrophobic material. Substrates can be coated with a hydrophobic material, such as triethoxysilane, trichlorovinylsilane, or trichlorosilane. In some embodiments, the substrate can be a silicon (Si) wafer. In some embodiments, the substrate can be treated with a silanizing agent to allow for manual detachment of the silk film from the substrate.

Patterns corresponding to optical devices can be formed on a surface of the substrate. In some embodiments, the patterns can be formed as recesses on the surface of the substrate. In some embodiments, the patterns can be elevated relative to a surface of the substrate. The patterns can be formed by fabrication techniques, such as 1 standard photolithography techniques, or any other technique as would be appreciated by one of ordinary skill in the art. For example, lithographic techniques that selectively remove portions of substrates can be used. In some embodiments, in e-beam lithography, a beam of electrons can be scanned in a pattern on a substrate. The beam can selectively remove either exposed or non-exposed regions of the substrate. In some embodiments, the substrate can be coated with Teflon™ to ensure even detachment after the silk fibroin solution dries to a film.

In some embodiments, the aqueous silk fibroin solution can be cast on the substrate. In some embodiments, the aqueous silk fibroin solution can be spin-coated on the surface of the substrate. The spin-coating can form thin membranes of silk that are non-uniform in height. The concentration of the silk fibroin solution and the spinning speed can affect the thickness of the resulting silk film. In some embodiments, the aqueous silk fibroin solution can be poured on a surface of the substrate.

The aqueous silk fibroin solution can be dried to transition the aqueous silk fibroin solution to the solid phase. As the aqueous solution dries, the resulting silk film can conform to the pattern on the substrate. Thus, the pattern on the substrate can be transferred to a silk film to form optical devices on the surface of the silk film. In some embodiments, the aqueous silk fibroin solution may be dried for a period of time such as 8-12 or 24 hours. In some embodiments, the solution can be subjected to low heat for expedited drying. Other exemplary drying techniques can include isothermal drying, roller drying, spray drying, and heating techniques.

The thickness of the silk film can depend on the volume of the silk fibroin solution applied to the substrate, the concentration of the silk in the solution, or any other factors. Film properties, such as thickness and silk content, as well as optical features, can be altered based on the concentration of fibroin used in the solution, the volume of the aqueous silk fibroin solution deposited, and the post deposition process for drying the cast silk solution to lock in the structure formed by the patterning. Accurate control of these parameters can be desirable to ensure the optical quality of the resultant optical device and to maintain various characteristics of the optical device, such as transparency, structural rigidity, and flexibility. Furthermore, additives to the silk fibroin solution can be used to alter features of the optical device such as morphology, stability, and the like, as known with polyethylene glycols, collagens, and the like. In some embodiments, a silk film can be 100 μm, 2 nm, 1 mm, or any other thickness.

In some embodiments, a silk film with optical devices can be annealed. The annealing can be performed in a vacuum environment, a water vapor environment, or a combination thereof. In some embodiments, the annealing can be performed within a water vapor environment (e.g., a chamber filled with water vapor) for different periods of time, depending on the material properties desired. Exemplary annealing time periods may range from between two hours to two days, for example, and may also be performed in a vacuum environment.

In some embodiments, the annealed or unannealed silk film can be manually detached from the substrate. The silk film can be detached via simple mechanical Mina of the film from the substrate. In some embodiments, the silk film can be detached by manually separating the silk film from the substrate using a razor film and lifting the film from the substrate. In some embodiments, the silk film can be peeled off the substrate. In some embodiments, an annealed silk film with optical devices can be subject to further drying.

In some embodiments, when the optical devices on the silk film form a reflector, the reflectivity of the silk film can be altered functionalizing the silk film with an agent. For example, the silk film can be activated by, e.g., polyethylene glycol {see, e.g., PCT/US09/64673) and/or loaded with an active agent and cultured with organisms, in uniform or gradient fashion. See, e.g., WO 2004/0000915; WO 2005/123114; U.S. Patent Application Pub. No. 2007/0212730. Other additives, such as polyethylene glycol, PEO, or glycerol, may also be loaded in the silk film to alter features of the silk film, such as morphology, stability, flexibility, and the like. See, e.g., PCT/US09/060,135.

In some embodiments, the patterned conductive structures can be formed on a silk matrix via transfer by contact. A pattern can be formed on a substrate. In some embodiments, the pattern can be etched into the substrate. In some embodiments, the pattern can be elevated relative to a surface of the substrate. In some embodiments, the pattern can be cast onto the substrate. In some embodiments, a silk matrix (e.g., a free-standing silk matrix) can be applied to the substrate. In some embodiments, pressure can be applied to the silk matrix and substrate to transfer the pattern from the substrate to the silk matrix. The transfer by contact can occur under ambient pressure and/or temperature conditions. In some embodiments, transfer by contact can occur at high temperature conditions.

In some embodiments, silk films with optical devices can be formed via machining a pattern corresponding to an optical device on a silk film. For example, an aqueous silk fibroin solution can be cast upon a flat surface. The solution can be left to dry into a solid silk film. Various fabrication techniques can be used to machine a pattern onto a surface of the silk film. Exemplary techniques include soft lithography and laser machining (e.g., application of femtosecond laser pulses to a surface of a silk film).

In some embodiments, photonic crystals can be formed by machining an array of holes and/or pits into a silk film. For example, holes and/or pits can be formed by applying femtosecond laser pulses from a commercial mode-locked titanium sapphire laser (e.g, Tsunami®, available through Spectra Physics Division of Newport Corporation) to a silk film. In some embodiments, the laser pulses last about 100 fs, the average power of the pulses is 1.1 W, the pulses are applied at a repetition rate of 80 MHz, and the wavelength can be 810 nm. The laser pulses can be focused by a moderate numerical aperture (NA=0.4) ball lens onto the silk films. The laser beam can be elliptical in shape due to an uncompensated astigmatism in the laser cavity. Without wishing to be bound by theory, in some embodiments, the shape of the beam is not reflected in the holes produced because of the nonlinear nature of the ablation process.

Multiple silk films with optical devices can be formed from any of the fabrication techniques discussed herein. Each silk film can have patterns (e.g., nanopatterns) formed on a surface thereof. In some embodiments, patterned silk films can be stacked. Adjacent silk films within the stack can be oriented to have different orientations. For example, a silk film can be rotated 90 degrees relative to a silk film above or below it in the stack. In some embodiments, the silk films in the stack have the same patterns on their surfaces. In some embodiments, the silk films in the stack have different patterns on their surfaces. In some embodiments, the silk films in the stack have different patterns such that, when stacked, the patterns operate together to produce a photonic crystal.

In some embodiments, the silk films can be bound together. For example, small quantities of the aqueous silk fibroin solution may be provided between the silk films to function as a glue between the films. The films can be crosslinked using enzymes (e.g., transglutaminase). Exemplary substances for binding the silk films include carbodimide, gluteraldehyde vapors, fibrin, and/or methacrylate, although other substances can be used.

In some embodiments, diffraction gratings can be formed on silk films to diffract light into its spectral components. The diffraction gratings can be formed, for example, using the methods described in U.S. Provisional Application No. 61/226,801 and/or PCT Application No. PCT/US2010/042585.

Any of the fabrication processes of the patterned conductive structures described herein can be conducted in a dry, chemical-free environment. Such an environment can reduce the likelihood of possible contamination that might be involved in other photolithography-based conductive material patterning methods, such as lift-off processes and wet-etching. Such methods help in maintaining the integrity and biocompatibility of the silk matrices without adversely affecting the matrices, thereby readily producing applications implantable into a human body, by way of example.

Transformation of Silk Films with Optical Devices to Powder

Silk films with optical devices can be selected for transformation into silk optical powder. The silk optical powder can retain at least one optical property of the optical devices formed on the silk film.

In some embodiments, each particle in a silk optical powder formed from a silk film with optical devices can include at least one optical device. In some embodiments, a particle can include more than one optical device. A particle can include an array of optical devices. A particle can include multiple optical devices of the same type (e.g., four microlenses). In some embodiments, the optical devices on the particle can be homogeneous (e.g., uniform sizes, focal lengths, line pitches, etc.). In some embodiments, the optical devices on the particle can be heterogeneous (e.g., different sizes, focal lengths, line pitches, etc.). A particle can include different types of optical devices. For example, a particle can include a lens and a diffraction grating. In some embodiments, a particle can have complete optical devices on one of its surfaces. In some embodiments, a particle can have partial optical devices on one of its surfaces (e.g., rifts in the silk film cut through at least one optical device). In some embodiments, particles in the silk optical powder can have homogenous sizes and/or shapes. In some embodiments, the particles can have heterogeneous sizes and/or shapes.

Sizes of particles can depend on the dimensions of optical devices on the silk films. In some embodiments, if the optical devices are nanoscale devices, silk films can be transformed into particles in the range of microns (e.g., about 1 μm to about 100 μm). A silk film with lenses that are 350 nm in diameter can be transformed into particles of about 35 μm. A silk film with lenses that are 475 nm in diameter can be transformed into particles of about 65 μm. In some embodiments, if the optical devices are micro-scale devices (e.g., microprisms, microlenses), silk films can be transformed into particles in the range of hundreds of microns (e.g., about 100 μm to about 1000 μm). A silk film with microprisms that have dimensions of 50 μm can be transformed into particles of about 400-600 μm. A silk film with microlens that have diameters of 75 μm can be transformed into particles of about 400-600 μm. Other proportions between the sizes of the optical devices and the sizes of the particles can be used.

In some embodiments, the silk films with optical devices are transformed into silk optical powder using at least one mechanical apparatus. Any mechanical apparatus can process the silk films. The mechanical apparatus can create rifts in the silk films, and the rifts can define the particles for the silk optical powder. In some embodiments, the mechanical apparatus can crush the silk film into powder. In some embodiments, the mechanical apparatus can cut the silk film into powder. In some embodiments, the mechanical apparatus can grind the silk film into powder. In some embodiments, the mechanical apparatus can chop the silk film into powder. In some embodiments, the mechanical apparatus can machine the silk film into powder.

In some embodiments, the mechanical apparatus can be a grinding machine. The grinding machine can include a rotating blade. The silk films can be introduced into the grinding machine and subjected to the rotating blade. In some embodiments, optical devices on these silk films can have dimensions on the order of hundreds of nanometers. In some embodiments, optical devices on these silk films can have dimensions smaller than hundreds of nanometers. In some embodiments, the length of time of grinding can result in particles of substantially homogenous sizes. In some embodiments, the types of rotating blades used in the grinding machine can result in particles of substantially homogenous sizes.

In some embodiments, the mechanical apparatus can be a chopping machine. The chopping machine can include at least one blade. The blade(s) can impact silk films with optical devices perpendicularly to create rifts in the films. Repeated chopping can result in particles with sizes ranging from 500 μm to 1 mm, by way of example. In some embodiments, chopping results in heterogeneously sized particles. In some embodiments, a silk film can be shaped as a ribbon, and the ribbon can be presented to the chopping machine in a substantially regular manner. For example, the ribbon can be fed into a cavity leading to blades of the chopping machine. A conveyer belt can present the silk film to the chopping machine at a substantially continuous rate. As the chopping machine regularly chops the silk film, the machine can thus produce particles of more uniform size.

In some embodiments, the silk films with optical devices are transformed into silk optical powder using at least one chemical. The silk films with optical devices can incorporate additional polymers besides silk fibroin, such as silk-polyethylene oxide or related polymers. In some embodiments, the additional polymer can define boundaries on silk films that can correspond to particles. In some embodiments, a chemical that dissolves the additional polymer can be applied to the silk film. As the additional polymer dissolves, the silk film can separate along boundaries defined by the polymer to create particles.

Fabrication of Various Optical Silk Powder

Silk film can be generated to have certain optical properties. Such silk film with the optical properties will subsequently be turned into a powder. Without wishing to be bound by theory, the powder maintains the optical properties, which are induced by nanoscale features. Accordingly, fibers and other material forms of silk can be patterned and then machined into particles or powders with various optical property, as described below:

Reflective Particles:

A mirror, either by microprism arrays or by a multi-layered silk, can be prepared and then processed into powders, resulting in reflective particles.

Diffractive Particles:

Diffractive structures like diffraction gratings can be generated in silk and then turned into diffractive powders, achieving the effect of glittering and multi-color iridescence.

2D-Diffractive and Photonic Crystals with Engineered Color:

Diffractive structures that exhibit a specific color or a single color pattern, based on the selection of appropriate surface patterns, can be engineered to generate structurally-colored powder, e.g., similar to the scales of a butterfly. This powder can be of one specific color.

Microlenses and Microsphere Arrays:

Optical powder can be engineered to act as light focusing particles or light concentrators.

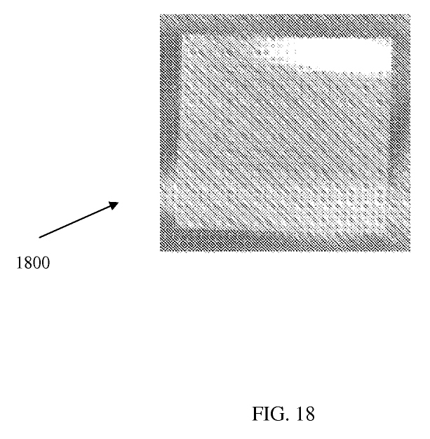

To fabricate diffractive powder, silk can be reformed into diffraction gratings that scatter and diffract white light into its spectral components, e.g., using the methods described in U.S. Provisional No. 61/226,801 and PCT Application Serial No.: PCT/US2010/042585. The outer appearance of a diffraction grating is shiny because of its way of handling radiation of different spectral components (FIG. 18). The grating can be reduced into powder by post-processing. This is accomplished by either by performing multiple cuts or mechanical grinding or other means. In some cases, this can also be accomplished by direct dissolution of a second polymer, such as after formatting and patterning films with silk-polyethylene oxide or related polymers. The resulting powders or pieces maintain their diffractive properties (a typical diffraction grating starts at 300 lines/mm and has pitches up to 3600 lines/mm).

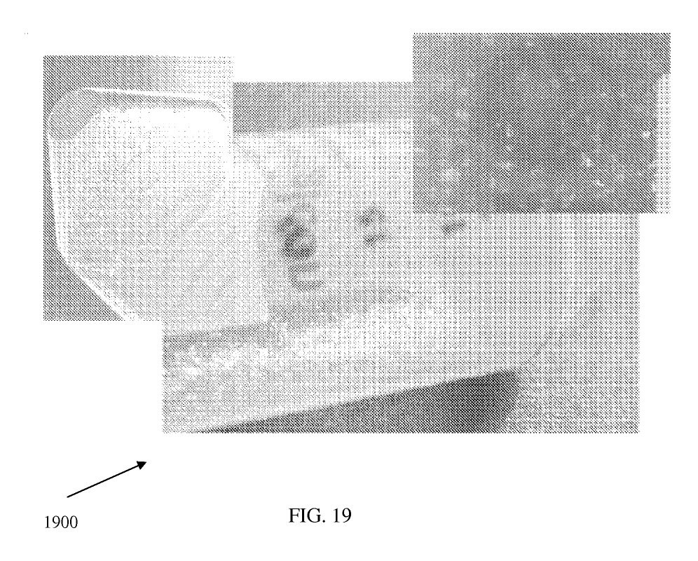

The grating is ground by freezing and mechanical crushing. The resulting iridescent powder is shown in FIG. 19. Optimization of the transition to a powder can provide improved optical function depending on the end-product.

In some embodiments, a particle composition of the present invention comprises silk particles with at least one optical property according to a selected application, using the methods as described in further detail below.

Silk particles that are useful for particle compositions of the present invention have at least one optical property can be prepared by a process including steps of: (a) providing a solid-state silk fibroin having at least one optical property; and (b) generating silk particle composition from the solid-state silk fibroin.

In some embodiments, the solid-state silk fibroin can be a replica of a master pattern having at least one optical structure or element. In some embodiments, one or more optical structures or elements can be formed on the surface of the solid-state silk fibroin through replicating from a master pattern having the optical structures or elements. The term “master pattern” as used herein refers to a mold or a template possessing the desired pattern to be replicated, e.g., on the surface of a solid-state silk fibroin. The master can be a milli-, micro-, or nano-patterned surface, and/or it can be an optical device or structure such as a lens, microlens, microlens array, prisms, microprisms array, pattern generator, diffraction gratings, and the like. Depending on the optical property desired for the solid-state silk fibroin and silk particle composition, any device or structure possessing the desirable optical feature can be used as a master pattern for the purpose of the invention. A diffractive silk grating can be replicated from a diffractive structure such as a diffraction grating. The resultant silk grating can then be reduced to diffractive silk particles, e.g., by a mechanical means.

The optical elements replicated from the master pattern can be a single optical element or optical elements in a 1-D, 2-D or 3-D array. By way of example, the reflective elements can be mirrors and retroreflectors with various shapes and geometries, including but not limited to flat mirrors, diamond-cut reflectors, retroreflectors with geometries such as a corner-cube, hemispherical geometry, “cat's-eye” geometry or the minor-backed lens (see, e.g., Lundvall et al., 11 Optics Express, 2459 (2003)), retro-reflecting cavities containing plurality of orthogonal intersecting planes, such as the corners of square, rectangular, or cubical cavities. The term “retroreflective” as used herein refers to the attribute of reflecting an obliquely incident light ray in a direction antiparallel to its incident direction, or nearly so, such that it returns to the light source or the immediate vicinity thereof.

The silk optical elements can be replicated from a master pattern by techniques known to one skilled in the art. In one embodiment, micromolding techniques akin to soft lithography (Perry et al., 20 Adv. Mater. 3070 (2008); Xia & Whitesides, 37 Angew. Chem. Int. Ed. 550 (1998)) was used to prepare the silk implantable optical component by replicating a reflective microprism array master mask. See also WO 2009/061823. For example, silk fibroin films can be patterned on the micro- and nano-scale using a soft lithography casting technique in which silk fibroin solution is cast on a pattern and dried. See Perry et al., 2008. The resulting device was a 100 μm thick free-standing silk reflector film with dimensions ranging from a few to a few tens of square centimeters. Similarly, a diffractive silk film can also be produced with a diffractive master pattern using similar micromolding techniques.

In other embodiments, room temperature nanoimprinting technique can also be used to prepare the silk optical components with fine features, such as those features having a minimum dimension of about 20 nm or less. See PCT/US2010/024004. Using the room-temperature nanoimprinting technique, the biological activity of some facile bioactive agents that are particularly sensitive to temperature can be preserved, further enabling facile production of bioactive nanoscale devices based on the silk optical devices/components.

Additional polymers, e.g., biocompatible and biodegradable polymers, can also be blended in the solid-state silk fibroin. For example, additional biopolymers, such as chitosan, exhibit desirable mechanical properties, can be processed in water, blended with silk fibroin, and form generally clear films for optical applications. Other biopolymers, such as chitosan, collagen, gelatin, agarose, chitin, polyhydroxyalkanoates, pullan, starch (amylose amylopectin), cellulose, alginate, fibronectin, keratin, hyaluronic acid, pectin, polyaspartic acid, polylysin, pectin, dextrans, and related biopolymers, or a combination thereof, may be utilized in specific applications, and synthetic biodegradable polymers such as polyethylene oxide, polyethylene glycol, polylactic acid, polyglycolic acid, polycaprolactone, polyorthoester, polycaprolactone, polyfumarate, polyanhydrides, and related copolymers may also be selectively used.

In some embodiments, the solid-state silk fibroin can be a composite of one or more layers of silk fibroin. Each layer of silk fibroin can possess the same or different composition or properties. For instance, each layer of silk fibroin can possess the same or different concentration of silk fibroin, and/or each layer can possess the same or different optical, mechanical and/or degradation properties. In one embodiment, the solid-state silk fibroin can be a multi-layered silk fibroin, e.g., which can be tuned to reflect specific wavelengths.

In some embodiments, the solid-state silk fibroin can be subjected to additional treatment, e.g., to modify the degradation rate of the silk fibroin. Additional treatment can include, but are not limited to, organic solvent treatment, mechanical treatment, or electromagnetic treatment. By way of example, the degradation rate of the silk fibroin can be controlled, e.g., by modifying the amount of beta-sheet crystal, and/or crystal orientation. Accordingly, the amount of beta-sheet crystal, and/or crystal orientation in a silk fibroin can be controlled by contacting the silk fibroin with alcohol, e.g., methanol or ethanol, as established in the art. In some embodiments, the silk fibroin can be subjected to a mechanical force, e.g., stretching, to vary the amount beta-sheet crystal, and/or alignment of the crystal orientation.

In some embodiments, the solid-state silk fibroin can be made piezoelectric, e.g., by mechanical means, as demonstrated in U.S. Provisional Application Ser. No. 61/386,592. Other methods that increase the degree of the alignment, e.g., uniaxial alignment, of the silk crystals can also be used to enhance the piezoelectricity of silk material. For example, the method may include aligning silk matrix in a magnetic field, e.g., by magnetic poling. The method may also include electronic poling of silk matrix to induce silk II structure or induction of other tensors of the piezoelectric matrix (in addition to the shear tensor) in silk matrix. The method may also include drawing silk matrix in OH— group rich solvents, or electrospinning and post-electrospinning treatment of silk for oriented, silk II, nanofibrillar mats. The piezoelectricity of silk material can be enhanced by maximizing silk II crystallinity and crystal alignment simultaneously, which may include combining different methods to process silk matrix. For example, electronic or magnetic poling can be combined with using OH— group rich solvents or electrospinning methods simultaneously or subsequently.

In accordance with the invention, the solid-state fibroin having with at least one optical property can be reduced to silk particles of the invention. As used herein, the term “reduced,” in reference to size, means that the solid-state fibroin can be processed into smaller size thereof, e.g., fragments, fibers, pieces, powders, by any means. For example, the solid-state silk fibroin can be reduced by a mechanical means, such as cutting, grinding, chopping, or machining. In some embodiments, the solid-state silk fibroin can be reduced by a chemical means, e.g., dissolution of a second polymer, such as after formatting and patterning a silk matrix with silk-polyethylene oxide or related polymers. The reduced silk fibroin, e.g., silk powder, can maintain the optical property (e.g., diffractive property) of the solid-state silk fibroin diffractive grating.

As described, the invention provides particle compositions comprising silk particles having at least one optical property. In some embodiments, compositions can further comprise non-silk particles, e.g., non-silk protein particles, inorganic particles, and polymeric particles. A person skilled in the art can select appropriate non-silk particles depending upon various applications. For example, inorganic particles, such as titanium oxide, can be added to the composition to enhance UV protection. Without wishing to be bound by theory, protein particles containing or enriched with residues such as tyrosine residue can also be added to the composition for UV protection, because tyrosine can naturally absorb UV rays.

In various embodiments, the silk particles can be modified. For instance, the silk particles can be genetically modified, which provides for further modification of the silk such as the inclusion of a fusion polypeptide comprising a fibrous protein domain and a mineralization domain, which are used to form an organic-inorganic composite. These organic-inorganic composites can be constructed from the nano- to the macro-scale depending on the size of the fibrous protein fusion domain used, see WO 2006/076711. See also U.S. patent application Ser. No. 12/192,588. In one embodiment, the silk particles can be genetically modified to enrich in one specific amino acid, e.g., for a desired optical property.

Accordingly, in some embodiments, recombinant silk fibroin having one or more mutations to the amino acid sequence of the fibroin polypeptide is useful for certain applications described herein. In come embodiments, one or more additional tyrosine residues are introduced into the polypeptide sequence. The native fibroin polypeptide contains approximately 5% tyrosine residues. Many of these residues are clustered across the polypeptide. In some embodiments, additional tyrosine residues are introduced into the sequence near the existing tyrosine residues of the polypeptide. Additionally or alternatively, amino acid residues with acid side chains may be substituted with tyrosine. In some embodiments, the resulting modified silk fibroin contains a higher percentage of tyrosine contents, relative to the native polypeptide. For example, modified silk fibroin suitable for certain embodiments of the invention may contain up to 5.5%, 6%, 7%, 8%, 9%, 10% or higher tyrosine residues. In some embodiments, additional and/or substituted tyrosine residues are located at or near the vicinity of the edge of the hydrophobic domains of the silk fibroin.

Silk fibroin can also be chemically modified with one or more agents in the solution, for example through diazonium or carbodiimide coupling reactions, avidin-biodin interaction, or gene modification and the like, to alter the physical properties and functionalities of the silk protein. See, e.g., PCT/US09/64673; PCT/US10/41615; PCT/US10/42502; U.S. application Ser. No. 12/192,588. In some embodiments, the silk particles can be coated with at least one agent, e.g., to alter its hydrophobicity or its interaction with surrounding molecules.

Pharmaceutical Composition, Optical Contrast Agents and Kits Thereof.

Since silk is biocompatible and edible, silk particles can be administered in vivo, e.g., for any medical applications such as biomedical imaging and biosensing. For example, the silk optical particles can be utilized to increase the amount of light that returns to a detector when a biological specimen is probed optically.

Accordingly, particle compositions described of the present invention comprising optic silk particles can be used as a biosensor or a diagnostic tool which are safe for in vivo use. In some embodiments, particle compositions comprising silk optic particles are generated from silk optic films or other suitable silk-solids, which are patterned as a series of nano-scale peaks and troughs. Such patterned silk film can then be reduced to smaller particles of, for example, nano-scale. The resulting particle composition now comprises silk particles which have at least one patterned surface. In some embodiments, during the fabrication of such silk composition, appropriate binding agent or agents may also be incorporated into the silk-based composition such that upon solidification process, the silk film now comprises one or more additional agents. In some embodiments, additional agents may be an affinity agent, such as monoclonal antibody, or fragment thereof. The composition can be introduced into a subject by any known methods, such as injection or oral administration, for suitable bio-detection use. For example, upon binding of specific target molecule(s), such as a pathogen or antigen present in the body of a subject to the patterned surface of silk particles, the optic properties of the silk particle shift. Such change in optic properties is indicative of the presence of the target molecule, which can then be detected by any appropriate means (e.g., imaging). Thus, the invention may be applied to a broad range of bio-imaging and bio-detection applications, based on the optic properties of particular silk particles and any additional agent coupled thereto.

Silk particles may be used as pharmaceutical carriers. In some embodiments, silk particles with certain optical properties may be associated with an affinity moiety or targeting moiety, which will localize the complex to specific sites (target molecule, tissues, etc.) in vivo. In some embodiments, targeting moiety may target a tumor cell. Thus, pharmaceutical composition comprising silk particles associated with such a targeting moiety can be administered into a subject having a tumor or suspected of having a tumor, and a tumor may be detected by any suitable optic imaging methods. In addition, in some embodiments, such silk-based imaging complex can also include one or more therapeutic agents, which then are released over time, depending on the degradation rates of the particular silk particles. Such effects can be monitored over time, again, using the same imaging methods. Thus, silk particle-based sensors and imaging reagents are safer alternatives to other agents known in the art. In a number of related medical and diagnostic applications, silk particles may replace more harmful reagents typically used in the art, including radioactive reagents.

As stated above, particle compositions comprise silk particles having at least one optical property are useful for pharmaceutical applications. In such embodiments, the pharmaceutical composition can further comprise at least one active agent. For example, the active agent can be mixed into the compositions described herein.

The active agent can be a therapeutic agent, or a biological material, such as cells (including stem cells), proteins, peptides, nucleic acids (e.g., DNA, RNA, siRNA), nucleic acid analogs, nucleotides, oligonucleotides, peptide nucleic acids (PNA), aptamers, antibodies or fragments or portions thereof (e.g., paratopes or complementarity-determining regions), antigens or epitopes, hormones, hormone antagonists, growth factors or recombinant growth factors and fragments and variants thereof, cell attachment mediators (such as RGD), cytokines, cytotoxins, enzymes, small molecules, drugs, dyes, amino acids, vitamins, antioxidants, antibiotics or antimicrobial compounds, anti-inflammation agents, antifungals, viruses, antivirals, toxins, prodrugs, chemotherapeutic agents, or combinations thereof. See, e.g., PCT/US09/44117; U.S. Patent Application Ser. No. 61/224,618). The agent can be also a combination of any of the above-mentioned agents.

In some embodiments, the active agent can be also an organism such as a fungus, plant, animal, bacterium, or a virus (including bacteriophage). Moreover, the active agent may include neurotransmitters, hormones, intracellular signal transduction agents, pharmaceutically active agents, toxic agents, agricultural chemicals, chemical toxins, biological toxins, microbes, and animal cells such as neurons, liver cells, and immune system cells. The active agents may also include therapeutic compounds, such as pharmacological materials, vitamins, sedatives, hypnotics, prostaglandins and radiopharmaceuticals.

Exemplary cells suitable for use herein may include, but are not limited to, progenitor cells or stem cells, smooth muscle cells, skeletal muscle cells, cardiac muscle cells, epithelial cells, endothelial cells, urothelial cells, fibroblasts, myoblasts, oscular cells, chondrocytes, chondroblasts, osteoblasts, osteoclasts, keratinocytes, kidney tubular cells, kidney basement membrane cells, integumentary cells, bone marrow cells, hepatocytes, bile duct cells, pancreatic islet cells, thyroid, parathyroid, adrenal, hypothalamic, pituitary, ovarian, testicular, salivary gland cells, adipocytes, and precursor cells. The active agents can also be the combinations of any of the cells listed above. See also WO 2008/106485; PCT/US2009/059547; WO 2007/103442.

Exemplary antibodies that can be included in the compositions described herein, but are not limited to, abciximab, adalimumab, alemtuzumab, basiliximab, bevacizumab, cetuximab, certolizumab pegol, daclizumab, eculizumab, efalizumab, gemtuzumab, ibritumomab tiuxetan, infliximab, muromonab-CD3, natalizumab, ofatumumab omalizumab, palivizumab, panitumumab, ranibizumab, rituximab, tositumomab, trastuzumab, altumomab pentetate, arcitumomab, atlizumab, bectumomab, belimumab, besilesomab, biciromab, canakinumab, capromab pendetide, catumaxomab, denosumab, edrecolomab, efungumab, ertumaxomab, etaracizumab, fanolesomab, fontolizumab, gemtuzumab ozogamicin, golimumab, igovomab, imciromab, labetuzumab, mepolizumab, motavizumab, nimotuzumab, nofetumomab merpentan, oregovomab, pemtumomab, pertuzumab, rovelizumab, ruplizumab, sulesomab, tacatuzumab tetraxetan, tefibazumab, tocilizumab, ustekinumab, visilizumab, votumumab, zalutumumab, and zanolimumab. The active agents can also be the combinations of any of the antibodies listed above.

Exemplary antibiotic agents include, but are not limited to, actinomycin; aminoglycosides (e.g., neomycin, gentamicin, tobramycin); β lactamase inhibitors (e.g., clavulanic acid, sulbactam); glycopeptides (e.g., vancomycin, teicoplanin, polymixin); ansamycins; bacitracin; carbacephem; carbapenems; cephalosporins (e.g., cefazolin, cefaclor, cefditoren, ceftobiprole, cefuroxime, cefotaxime, cefipeme, cefadroxil, cefoxitin, cefprozil, cefdinir); gramicidin; isoniazid; linezolid; macrolides (e.g., erythromycin, clarithromycin, azithromycin); mupirocin; penicillins (e.g., amoxicillin, ampicillin, cloxacillin, dicloxacillin, flucloxacillin, oxacillin, piperacillin); oxolinic acid; polypeptides (e.g., bacitracin, polymyxin B); quinolones (e.g., ciprofloxacin, nalidixic acid, enoxacin, gatifloxacin, levaquin, ofloxacin, etc.); sulfonamides (e.g., sulfasalazine, trimethoprim, trimethoprim-sulfamethoxazole (co-trimoxazole), sulfadiazine); tetracyclines (e.g., doxycyline, minocycline, tetracycline, etc.); monobactams such as aztreonam; chloramphenicol; lincomycin; clindamycin; ethambutol; mupirocin; metronidazole; pefloxacin; pyrazinamide; thiamphenicol; rifampicin; thiamphenicl; dapsone; clofazimine; quinupristin; metronidazole; linezolid; isoniazid; piracil; novobiocin; trimethoprim; fosfomycin; fusidic acid; or other topical antibiotics. Optionally, the antibiotic agents may also be antimicrobial peptides such as defensins, magainin and nisin; or lytic bacteriophage. The antibiotic agents can also be the combinations of any of the agents listed above. See also PCT/US2010/026190.

Exemplary enzymes that can be included in the compositions, but are not limited to, peroxidase, lipase, amylose, organophosphate dehydrogenase, ligases, restriction endonucleases, ribonucleases, DNA polymerases, glucose oxidase, laccase, and the like. Interactions between components may also be used to functionalize silk fibroin through, for example, specific interaction between avidin and biotin. The active agents can also be the combinations of any of the enzymes listed above. See U.S. Patent Application Ser. No. 61/226,801.

Other materials known in the art may also be added to the pharmaceutical compositions. For instance, it may be desirable to add materials to promote the growth of the agent (for biological materials) or increase the agent's ability to survive or retain its efficacy during storage. Materials known to promote cell growth include cell growth media, such as Dulbecco's Modified Eagle Medium (DMEM), fetal bovine serum (FBS), non-essential amino acids and antibiotics, and growth and morphogenic factors such as fibroblast growth factor (FGF), transforming growth factors (TGFs), vascular endothelial growth factor (VEGF), epidermal growth factor (EGF), insulin-like growth factor (IGF I), bone morphogenetic growth factors (BMPs), nerve growth factors, and related proteins may be used. Growth factors are known in the art, see, e.g., Rosen & Thies, CELLULAR & MOLECULAR BASIS BONE FORMATION & REPAIR (R. G. Landes Co., Austin, Tex., 1995). Additional materials can include DNA, siRNA, antisense, plasmids, liposomes and related systems for delivery of genetic materials; peptides and proteins to activate cellular signaling cascades; peptides and proteins to promote mineralization or related events from cells; adhesion peptides and proteins to improve particle-tissue interfaces; antimicrobial peptides; and proteins and related compounds. The pharmaceutical compositions can also comprise hydroxyapatite particles, see PCT/US08/82487.

In some embodiments, the pharmaceutical composition can further comprise one or more pharmaceutically-acceptable carrier. As used herein, the term “pharmaceutically-acceptable carrier” means a pharmaceutically-acceptable material, composition or vehicle, such as a liquid, diluent, excipient, manufacturing aid or encapsulating material, involved in carrying or transporting the subject compound from one organ, or portion of the body, to another organ, or portion of the body. Each carrier must be “acceptable” in the sense of being compatible with the other ingredients of the formulation and not injurious to the patient. Some examples of materials which can serve as pharmaceutically-acceptable carriers include, but are not limited to, gelatin, buffering agents, such as magnesium hydroxide and aluminum hydroxide, pyrogen-free water, isotonic saline, Ringer's solution, pH buffered solutions, bulking agents such as polypeptides and amino acids, serum component such as serum albumin, HDL and LDL, and other non-toxic compatible substances employed in pharmaceutical formulations. Preservatives and antioxidants can also be present in the formulation. The terms such as “excipient”, “carrier”, “pharmaceutically acceptable carrier” or the like are used interchangeably herein.

The pharmaceutical compositions can be specially formulated for administration in solid or liquid form, including those adapted for the following: (1) oral administration, for example, drenches (aqueous or non-aqueous solutions or suspensions), lozenges, dragees, capsules, pills, tablets (e.g., those targeted for buccal, sublingual, and systemic absorption), boluses, powders, granules, pastes for application to the tongue; (2) parenteral administration, for example, by subcutaneous, intramuscular, intravenous or epidural injection as, for example, a sterile solution or suspension, or sustained-release formulation; (3) topical application, for example, as a cream, ointment, or a controlled-release patch or spray applied to the skin; (4) intravaginally or intrarectally, for example, as a pessary, cream or foam; (5) sublingually; (6) ocularly; (7) transdermally; (8) transmucosally; or (9) nasally. Additionally, compounds can be implanted into a patient or injected using a drug delivery system. See, for example, Urquhart, et al., Ann. Rev. Pharmacol. Toxicol. 24: 199-236 (1984); Lewis, ed. “Controlled Release of Pesticides and Pharmaceuticals” (Plenum Press, New York, 1981); U.S. Pat. No. 3,773,919; and U.S. Pat. No. 35 3,270,960. As used herein, the term “administer” or “administration” refers to the placement of a composition into a subject by a method or route which results in at least partial localization of the composition at a desired site such that desired effect is produced.

In accordance with the invention, the silk optical particles are biodegradable. Hence, the silk optical particles can disappear or resorb over time. In some embodiments, the dissolution or degradation time of the silk optical particles can be tuned from minutes to hours to days to months by controlling the degree of crystallinity during the fibroin protein self-assembly process. Jin et al., 15 Adv. Funct. Mater. 1241 (2005); Lu et al., 6 Acta Biomater. 1380 (2010). This can be accomplished, e.g., by regulating the water content within the silk film through an annealing step to stabilize the device for prolonged operation in wet environments such as those encountered in the in vitro and/or in vivo studies. Other treatment methods known in the art for altering the degree of crystallinity in the silk fibroin can be also employed.

In accordance with the invention, the silk optical particles can be used as an optical imaging agent, e.g., in biomedical imaging, such as contrast agent. Accordingly, a further aspect of the invention relates to an optical contrast agent comprising silk particles having at least one optical property. In such embodiments, the dissolution time of the silk optical particles can be tuned to persist for a period of time, e.g. about 1 hr, about 2 hours, about 3 hours, about 4 hours, about 5 hours, about 6 hours, about 12 hours, about 1 day, about 1 week or longer. In one embodiment, the dissolution time of the silk optical particles can be tuned to persist long enough in a subject's body for biomedical imaging, and then degrade. The term “degrade”, “degradation” or “dissolution” as used herein refers to a decrease in the amount or size of silk particles. The process of degradation or dissolution can last over a period of time, e.g., at least about 5 minutes, at least about 10 minutes, at least about 15 minutes, at least about 30 minutes, at least about 1 hour, at least about 2 hours, at least about 3 hours, at least about 6 hours, at least about 12 hours, at least about 1 day, at least about 2 days, at least about 1 week, at least about 2 weeks, at least about 3 weeks, at least about 1 month or longer.

In additional embodiments, the optical property of the silk particles can be modified to assign a specific spectral signature that can be effectively detected. For example, based on selection of an appropriate master pattern, diffractive silk particles can be designed to exhibit one specific color. In some embodiments, the optical property of the silk particles can be modified to induce reflectivity, e.g., to monitor fluid flow in vivo.

Kits, e.g., useful for medical applications, are also provided herein. The kit includes (1) the pharmaceutical composition or the optical contrast agent described herein, and (2) a pharmaceutically acceptable solution described herein, e.g., water, or buffered solutions. In some embodiments, the kit further comprises at least one syringe, or at least one catheter, e.g., for administration of the compositions.

Articles of Manufacture

Another aspect of the invention is directed to an article of manufacturer bearing one or more optical effects, e.g., reflection, diffraction, refraction, absorption, optical gain fluorescence, and/or light scattering. Such articles of manufacturer can include, but are not limited to, toys, arts, crafts, ornamental objects, paints, inks, apparel, textiles, hair care products, paper products, edible products, cosmetics, lens, signs and displays. In embodiments of the invention, the article of manufacturer includes at least one composition described herein.

In some embodiments, the article of manufacturer can comprise reflective silk particles. In some embodiments, the article of manufacturer can comprise diffractive silk particles. In some embodiments, the article of manufacturer can comprise photonic silk crystal particles. In such embodiments, the photonic silk crystal powder can be of one specific color. In some embodiments, the article of manufacturer can comprise fluorescent silk particles.

These various silk optical particles can be utilized in various applications. For example, silk optical particles can be dispersed in paints or inks. Such paints or inks can be used to provide reflective or glittering makers such as edge and lane striping, signs, displays, and the like. In some embodiments, such paints or inks can be used to for face or body paintings, including tattoos. In certain embodiments, the paints or inks can comprise reflective silk particles. Without wishing to be bound by theory, the reflective silk particles can be designed to reflect a certain wavelength of light, e.g., infra-red or UV. Accordingly, in some embodiments, the paints or inks comprising reflective silk particles can be used as a heat reflective paint, e.g., on the surface of a roof or glass windows.

In some embodiments, silk optical particles can be added to textiles of any kinds. For example, silk optical particles can be added to surface of textiles or apparel, such as by electrostatics. Alternatively, silk optical particles can be processed into the textiles or apparel during manufacture.

In some embodiments, silk optical particles can be added to hair care products, such as hair colorings, hair gloss, hair glaze, and shampoos, conditioners. Due to its biocompatible nature, in some embodiments, silk optical particles can be added to lens, e.g., contact lens.

In some embodiments, the silk optical particles can be added to toys, e.g., PLAY-DOH® used by children as a modeling compound for arts and crafts projects.

As noted herein, silk optical particles can be edible and may be flavored. In some embodiments, silk optical particles can be dispersed in edible products. In one embodiment, silk optical particles can be added into vitamins, nutraceuticals, or other pharmaceuticals, e.g., produced for pediatric use. In other embodiments, silk optical particles, can be added to candies or chewing gums, e.g., to enhance their attractiveness. Accordingly, a food additive comprising at least one composition disclosed herein also falls within the scope of the invention.

Optical Coatings and Uses Thereof

Silk optical particles, e.g., powders, can be employed to form an optical coating on an object. Accordingly, one aspect of the invention relates to an optical coating comprising at least one composition described herein. The optical coating can be applied on the surface of an object, e.g., using any coating methods known in the art. Exemplary coating methods can be thin-film coating, wet coating (e.g., dip coating), or powder coating. In some embodiments, silk particle composition may be provided as an aerosol and are sprayed or misted onto a desired surface.

In some embodiments, the optical coating can be applied on food produces. In some embodiments, the optical coating can be applied on skin of food produces, e.g., agricultural produces such as fruits and vegetables. Different embodiments of the optical coating can be used for various purposes. In one embodiment, silk optical particles acting as light concentrators can be used to focus sunlight onto the food produce, e.g., fruit skin, and increase the ripening rate. In one embodiment, silk optical particles acting as light reflectors can be used to reduce heat stress on food produce, e.g., by reflecting UV rays. In one embodiment, silk optical particles acting as light reflectors can be used to make food skin color look better. Thus, silk particle composition may be used in lieu of conventional food wax for coating various food. Alternatively, silk particle composition may be added into a wax composition to improve appearance. Alternatively or additionally, silk particle composition may be used in conjunction with one or more flavorings, extracts or scented agents such as perfumes.

In some embodiments, the optical coating can be applied on an energy-harvesting device, e.g., a solar cell. In such embodiments, optical silk powders acting as light concentrators can be sprayed or painted onto solar cells for focusing sunlight into the solar cells. In other embodiments, optical silk powders acting as light absorbers can be sprayed or painted onto an energy-storage device to absorb sunlight and store the energy.

In some embodiments, the optical coating can be applied on a photosensitive object, e.g., chemical compounds, antiques, arts, crafts, packaging materials or edible products. In such embodiments, optical silk powders can be designed to offer protection against a specific wavelength of light. For example, an optical coating can be applied on a photosensitive drug to protect them from light degradation, e.g., UV degradation.

Cosmetic Compositions, Sunscreen Compositions, and Uses Thereof.

As described herein, optical silk particles can provide a glittering effect or a specific color, based on selection of an appropriate master pattern. For example, diffractive structures can be used as a master pattern to generate diffractive silk particles for a glittering or iridescent effect. In some embodiments, diffractive structures can also be used as a master pattern to generate photonic silk crystal particles, e.g., of one specific color. In accordance with the invention, another aspect relates to cosmetic compositions and methods for improving appearance of human skin complexion.

Embodiments of a cosmetic composition comprise at least one composition described herein. In some embodiments, the optical silk particles can have a reflected wavelength in a range comparable to the reflected wavelength of a skin complexion, thereby enhancing the appearance of the desired skin complexion. In some embodiments, the optical silk particles can reflect more than one wavelength of light and thus have more than one reflected wavelength. In various embodiments, the reflected wavelength can be in a range of about 400 nm to about 700 nm, which is the range of wavelength for visible lights.

In some embodiments, the optical silk particles can have a reflected wavelength in a range comparable to the wavelengths of one or more desired colors, e.g., any color in a color palette. Optical silk particles with a different reflected wavelength can be generated, e.g., using various configurations of diffractive structures, for various types of cosmetic products, such as lipsticks, foundation, eyeliners, blush, bronzers, eye-shadows, and mascaras.

In some embodiments, the silk particles can impart an iridescence effect. Iridescence is generally known as a property of certain surfaces, which appear to change color as the angle of view or the angle of illumination changes, and it can be caused by multiple reflections.

In some embodiments, the cosmetic composition can include any ingredients that are generally incorporated into this type of compositions. Non-limiting examples of such ingredients include water, moisturizing components, thickening and stabilizing agents for emulsion, preservatives, mineral oil, volatile components, fragrance or hydrocarbon-based compounds. The cosmetic compositions of the invention can be in a form of a powder, pressed powder, liquid, emulsion, cream, lotion, gel, aerosol, ointment or solid stick. A skilled artisan can determine appropriate ingredients for different forms of cosmetics compositions.

Any embodiments of the cosmetic compositions herein can be used to improve appearance of human skin complexion. The method includes (a) providing the cosmetic composition of the invention, and (b) applying the cosmetic composition on human skin to improve appearance of the human skin complexion. As used herein, the term “complexion” refers to the natural color and/or texture of the skin, e.g., the face or the body. In some embodiments, the term “complexion” refers to evenness of skin color, which can be reduced by the presence of imperfections, e.g., age spots or skin discoloration. Evenness of skin color can be measured, e.g., by identifying the gradations in color from the surrounding skin using methods available in the art.

Alternatively or additionally, silk particle composition may be used in conjunction with one or more pigments or colorings. In some embodiments, silk particle composition may be sued for the manufacture of nail polish, hair spray, skin simmering lotion etc., which may be provided in conjunction with additional pigments or colorings, and/or additional agents such as perfume.

As noted herein, silk optical particles can be generated to reflect a specific wavelength of light, e.g., UV rays. Thus, silk optical particles can be used as a natural sunscreen. Accordingly, sunscreen compositions and methods for protecting epidermis or hair against UV rays are also provided herein. In one aspect, embodiments of the sunscreen composition comprises (1) at least one composition or at least one cosmetic composition described herein, and (2) at least one cosmetically or pharmaceutically-acceptable carrier.

As used herein “cosmetically acceptable” means a material (e.g., compound or composition) which is suitable for use in contact with skin and/or hair. The phrase “cosmetically acceptable carrier”, as used herein means one or more compatible solid or liquid fillers, diluents, extenders and the like, which are cosmetically acceptable as defined hereinabove.

In some embodiments, the silk optical particles can be modified to have an amino acid sequence enriched in at least one type of amino acids that absorb UV rays, e.g., with a wavelength of about 10 nm to about 400 nm. In some embodiments, the silk optical particles can be modified to have an amino acid sequence enriched in at least one type of amino acids that reflect UV rays. For example, tyrosines can naturally absorb UV light. As such, in some embodiments, the silk optical particles can be modified to have an amino acid sequence enriched in tyrosine residues. In some embodiments, the sunscreen composition described herein can further comprise non-silk particles, e.g., any non-silk particles that absorb, reflect or scatter UV rays such as inorganic molecules. Exemplary non-silk particles that absorb, reflect or scatter UV rays can include zinc oxide or titanium oxide. Other active ingredients often found in a sunscreen can also be included in the sunscreen compositions described herein, e.g, oxybenzone, p-Aminobenzoic acid, octyl methoxycinnamate, Mexoryl XL, Parsol SLX, and avobenzone.

In another aspect, methods of protecting epidermis or hair against UV rays comprises the steps of: (a) providing the cosmetic composition or the sunscreen composition described herein, and (b) applying any of the compositions in step (a) on the epidermis or hair to protect epidermis or hair against UV rays. As used herein, the term “epidermis” refers to the outer layer of the skin. The term “protecting” as used herein refers to reducing UV rays from contacting and/or reacting with the skin exposed to sunlight, e.g., by absorbing or reflecting some of UV radiation on the skin exposed to sunlight, and thus providing protection against sunburn. In some embodiments, the compositions described herein can reduce UV rays from contacting and/or reacting the skin by at least about 5%, at least about 10%, at least about 20%, at least about 30%, at least about 40%, at least about 50%, at least about 60%, at least about 70%, at least about 80%, at least about 90%, at least about 95%, or at least about 99% or 100%.

In some embodiments, the compositions described herein can be applied on the epidermis or hair, e.g., by spraying or rubbing. Methods of the invention can be applied to any subject, e.g., a mammal. As used herein, a “subject” can mean a human or an animal. Examples of subjects include primates (e.g., humans, and monkeys). Usually the animal is a vertebrate such as a primate, rodent, domestic animal or game animal. In one embodiment, the subject is a mammal. The mammal can be a human, non-human primate, mouse, rat, dog, cat, horse, or cow, but are not limited to these examples. In addition, the methods and compositions described herein can be employed in domesticated animals and/or pets.

Other than protection against UV rays, methods for protecting an object or a matter against a pre-determined wavelength of light are also provided herein. The method includes (a) providing the composition described herein, and (b) applying the composition on the object against the pre-determined wavelength of light. Examples of an object can include, but are not limited to, epidermis, hair, or photosensitive objects such as chemical compounds, antiques, arts, crafts, paper products, apparel, textiles, packaging materials and edible products. In some embodiments, the composition can be applied on the object as a coating.

In some embodiments, the pre-determined wavelength of light can be any wavelength to which the object is photosensitive. In some embodiments, the pre-determined wavelength of light can correspond to UV (e.g., about 10 nm-about 400 nm). In some embodiments, the pre-determined wavelength of light can correspond to infra-red (e.g., 0.7 μm to 300 μm).

Some Selected Definitions

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments of the aspects described herein, and are not intended to limit the paragraphed invention, because the scope of the invention is limited only by the paragraphs. Further, unless otherwise required by context, singular terms shall include pluralities and plural terms shall include the singular.

As used herein the term “comprising” or “comprises” is used in reference to compositions, methods, and respective component(s) thereof, that are essential to the invention, yet open to the inclusion of unspecified elements, whether essential or not.

The term “consisting of” refers to compositions, methods, and respective components thereof as described herein, which are exclusive of any element not recited in that description of the embodiment.

Other than in the operating examples, or where otherwise indicated, all numbers expressing quantities of ingredients or reaction conditions used herein should be understood as modified in all instances by the term “about.” The term “about” when used in connection with percentages may mean±1%.

The singular terms “a,” “an,” and “the” include plural referents unless context clearly indicates otherwise. Similarly, the word “or” is intended to include “and” unless the context clearly indicates otherwise. Thus for example, references to “the method” includes one or more methods, and/or steps of the type described herein and/or which will become apparent to those persons skilled in the art upon reading this disclosure and so forth.

Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

In one respect, the present invention relates to the herein described compositions, methods, and respective component(s) thereof, as essential to the invention, yet open to the inclusion of unspecified elements, essential or not (“comprising”). In some embodiments, other elements to be included in the description of the composition, method or respective component thereof are limited to those that do not materially affect the basic and novel characteristic(s) of the invention (“consisting essentially of”). This applies equally to steps within a described method as well as compositions and components therein. In other embodiments, the inventions, compositions, methods, and respective components thereof, described herein are intended to be exclusive of any element not deemed an essential element to the component, composition or method (“consisting of”). The present invention is not limited to the particular methodology, protocols, and reagents, etc., described herein and as such may vary. The terminology used herein is for the purpose of describing particular embodiments only, and is not intended to limit the scope of the present invention, which is defined solely by the claims.

The Present Invention May be Defined in any of the Following Numbered Paragraphs:

A composition comprising silk particles engineered with at least one optical property.

The composition of paragraph 1, wherein the silk particles are prepared by a process comprising the steps of:

providing a solid-state silk fibroin engineered with the at least one optical property; and

reducing the solid-state silk fibroin into the silk particles.

The composition of paragraph 1 or 2, wherein the solid-state silk fibroin is a replica of a master pattern having at least one optical structure.

The composition of any of paragraphs 1-3, wherein the process further comprises additional treatment of the solid-state silk fibroin.

The composition of any of paragraphs 1-4, wherein the at least one optical property is selected from a group consisting of reflectivity, diffraction, refraction, absorption, optical gain, fluorescence, and light scattering.

The composition of any of paragraphs 1-5, wherein the solid-state silk fibroin is a silk film.

The composition of any of paragraphs 1-6, wherein the silk particles comprise at least one layer of silk fibroin.

The composition of any of paragraphs 1-7, wherein the silk particles further comprise a polymer.

The composition of paragraph 8, wherein the polymer is a biocompatible polymer.

The composition of paragraph 8 or 9, wherein the polymer is a biodegradable polymer.

The composition of any of paragraphs 1 to 10, further comprising non-silk particles.

The composition of paragraph 11, wherein the non-silk particles are selected from the group consisting of: protein particles, inorganic particles, and polymeric particles.

The composition of any of paragraphs 1 to 12, wherein the silk particles are modified.

A pharmaceutical composition comprising the composition of any of paragraphs 1 to 13.

An optical contrast agent comprising the composition of any of paragraphs 1 to 13.

A kit comprising the pharmaceutical composition of paragraph 14 or the optical contrast agent of paragraph 13, and a pharmaceutically acceptable solution.

The kit of paragraph 16, further comprising at least one syringe.

The kit of paragraph 16 or 17, further comprising at least one catheter.

An article of manufacturer bearing one or more optical effects comprising at least one composition of any of paragraphs 1 to 13.

The article of manufacturer of paragraph 19, wherein the article is selected from the group consisting of toys, arts, crafts, ornamental objects, paints, inks, apparel, textiles, hair care products, paper products, edible products, cosmetics, lens, signs, and displays.

An optical coating comprising at least one composition of any of paragraphs 1 to 13.

The optical coating of paragraph 21, wherein the coating is applied on food produce.

The optical coating of paragraph 21 or 22, wherein the coating is applied on an energy-harvesting device.

The optical coating of paragraph 23, wherein the energy-harvesting device is a solar cell.

A food additive comprising at least one composition of any of paragraphs 1 to 13.

A cosmetic composition comprising at least one composition of any of paragraphs 1 to 13.

The cosmetic composition of paragraph 26, wherein the reflected wavelength of the silk particles is in a range comparable to the reflected wavelength of a skin complexion, thereby enhancing the appearance of the desired skin complexion.

The cosmetic composition of paragraph 26 or 27, wherein the reflected wavelength of the silk particles is in a range comparable to the wavelengths of one or more desired colors.

The cosmetic composition of any of paragraphs 26-28, wherein the silk particles impart an iridescence effect.

The cosmetic composition of any of paragraphs 26-29, wherein the composition is in a form of a powder, pressed powder, liquid, emulsion, cream, lotion, gel, aerosol, ointment, or solid stick.

A sunscreen composition for protecting epidermis or hair against UV rays, comprising at least one composition of any of paragraphs 1 to 13, or at least one cosmetic composition of any of paragraphs 26 to 30, and at least one cosmetically or pharmaceutically acceptable carrier.

The sunscreen composition of paragraph 31, wherein the silk particles are modified to have an amino acid sequence enriched in at least one type of amino acids that absorb UV rays.

The sunscreen composition of paragraph 31 or 32, further comprising non-silk particles.

The sunscreen composition of paragraph 33, wherein the non-silk particles absorb or reflect UV rays.

A method of protecting an object against a pre-determined wavelength of light, comprising the steps of:

providing the composition of any of paragraphs 1 to 13; and

applying the composition on the object/matter to protect the object/matter against the pre-determined wavelength of light.

The method of paragraph 35, wherein the object is epidermis or hair.

The method of paragraph 35 or 36, wherein the object is photosensitive.

The method of paragraph 37, wherein the photosensitive object is selected from a group consisting of chemical compounds, antiques, arts, crafts, paper products, apparel, textiles., packaging materials, and edible products

The method of any of paragraphs 35-38, wherein the pre-determined wavelength of light corresponds to ultra-violet.

The method of any of paragraphs 35-39, wherein the pre-determined wavelength of light corresponds to visible light.

A method of improving appearance of human skin complexion, comprising the steps of:

providing the cosmetic composition of any of paragraphs 26 to 30; and

applying the cosmetic composition on human skin to improve appearance of the human skin complexion.

A method of protecting epidermis or hair against UV rays, comprising the steps of:

providing the cosmetic composition of any of paragraphs 26 to 30, or the sunscreen composition of any of paragraphs 31 to 34; and

applying any of the compositions in step (a) on the epidermis or hair to protect epidermis or hair against UV rays.

A method of preparing silk optical powder, comprising the steps of:

forming an optical pattern into a silk matrix; and

processing the optical patterned silk matrix into a silk optical powder.

### EXAMPLES

### Example 1

Preparation of Silk Films

Bombyx mori cocoons were processed in to soluble silk fibroin solution and then cast on polydimethylsiloxane (PDMS) molds.

Silk fibroin solution was obtained as previously described. See Perry et al., Adv. Mater., 20: 3070-72 (2008); Sofia et al., J. Biomed. Mats. Res. 54: 139 (2001). Briefly, Bombyx mori cocoons were cleaned and cut into small pieces. In a subsequent degumming process, sericin, a water-soluble glycoprotein bound to raw silk fibroin filaments, was removed from the silk strands by boiling Bombyx mori cocoons in a 0.02 M aqueous solution of NaCO₃ for 60 minutes. The resulting silk fibroin was dried and then dissolved in a 9.3 M aqueous solution of LiBr at 60° C. for 4 hours. The LiBr salt was removed from the silk fibroin solution over the course of several days, through a water-based dialysis process using Slide-A-Lyzer® 3.5K MWCO dialysis cassettes (Pierce, Rockford, Ill.). The resulting solution was then centrifuged and filtered via syringe based micro-filtration (5 μm pore size, Millipore Inc., Bedford, Mass.) to remove any remaining particulates. This process can yield 6%-10% (w/v) silk fibroin solution with minimal contaminants and reduced scattering for optical applications. The silk fibroin solution may be diluted to a lower concentration.

The silk fibroin solution may also be concentrated, for example, to about 30% (w/v). See, e.g., WO 2005/012606. Briefly, the silk fibroin solution with a lower concentration may be dialyzed against a hygroscopic polymer, such as PEG, amylose or sericin, for a time period sufficient to result in a desired concentration.

After preparation of the silk fibroin solution, 15 mL of the solution was cast on a flat PDMS mold (3 inch×5 inch) and allowed to crystallize in air overnight. The resulting film was easily removed from the PDMS and was approximately 80 μm thick. See Lawrence et al., Biomacromolecules, 9: 1214-20 (2008). Adjusting the concentration and/or the volume of the silk fibroin solution cast on the substrate and curing parameters can result in silk films from 2 nm to 1 mm thick. Alternatively, the silk fibroin solution can be spin-coated on a substrate using various concentrations and spin speeds to produce films from 2 nm to 100 μm. The resulting silk fibroin films were observed to have excellent surface quality and optical transparency.

### Example 2

### Chemical Modifications of Silk Fibroin

In some embodiments, silk fibroin for use in accordance with the present invention can be chemically modified, e.g., with one or more active agents, for example through diazonium or carbodiimide coupling reactions, avidin-biodin interaction, or gene modification and the like, to alter the physical properties and functionalities of the silk protein. See, e.g., PCT/US09/64673; U.S. Applications Ser. No. 61/227,254; Ser. No. 61/224,618; Ser. No. 12/192,588, which are incorporated herein by reference in their entirety.

Additional functionalities may be conferred to the silk matrix, for example, through enzymatically polymerization, a conducting polymer can be generated between silk film and the substrate supporting the film, making an electroactive silk matrix, and providing potentials of electro-optical devices. See, e.g., WO 2008/140562, which is incorporated herein by reference in its entirety.

### Example 3

### Fabrication of Silk Films Via Electrogelation (“e-Gel”)

Current methods to produce silk films include casting and spin coating. We introduce a new method for the fabrication of silk films: electrogelation. By using a closed-loop anode, the controlled application of electrical current to regenerated silk fibroin (RSF) solution yields a silk gel which, upon drying, forms an optically transparent film. This technique allows for the rapid production of freestanding mechanically robust thin films with desirable characteristics that include exceptionally low surface roughness, curved geometries, and thicknesses into the nanoscale.

Recently it has been established that RSF solution, derived from Bombyx mori silkworms, responds to direct current (DC) electrical stimulation by aggregating around the anode and forming a gel, called an e-gel to specify the method of its formation.^{[1-3]} A common thread in preceding works is the use of simple electrodes that are rod-like in their geometry. In this paper, we expound upon this 1-D approach to show that configuration of the positive electrode into a closed loop leads to the formation of silk films that are circumscribed by the loop itself. Moreover, in contrast to other electrodeposition studies, both with silk and other biopolymers, the resulting e-gel films possess no underlying surface, supported only at the films' edges.^{[1-10]} In the simplest case, the loop lies within a 2-D plane, and a flat circular film is produced. In addition, through manipulation of the loop, a number of 3-D topologies can be realized.

The mechanism of e-gel assembly is primarily driven by a localized decrease in solution pH, a byproduct of the electrolysis of water.^{[2,3]} The electrical current required is small, less than 1 mA. While a current is applied, the local pH in the vicinity of the anode decreases, and oxygen gas is released by the following reaction:

$${H}_{2} O \to \frac{1}{2} {O}_{2} + 2 {H}^{+} + 2 {e}^{-} \qquad ( 1 )$$

Conversely, fluid in the vicinity of the cathode experiences an increase in pH and hydrogen bubbles are released as follows:

1. 2H₂O+2e⁻→2OH⁻+H₂ (2)

A solution more acidic than pH 4.4 appears red, while one that is more basic than pH 6.2 appears yellow. Using short-range pH paper, the initial pH of silk solution was measured as 6.5. With increasing time, acidification of the local environment around the anode is evident and expanding.

Local changes in pH induce conformational changes within the silk molecule. A number of papers examining the gelation of silk solution have shown that a pH of approximately 5 serves as a critical threshold, below which silk solution will gel rapidly.^{[2,14,15]} This also is consistent with studies of silkworm physiology which have found that the transition of silkworm silk solution dope in the gland to a spinnable gel occurs at pH 4.8.^{[16,17]}

The role of electric charge in the process is significant as well. Silk molecules are negatively charged, and throughout the literature, experimental measurements of the isoelectric point (pI) of silk fibroin fall between 3.6-4.2, well below the initial pH of RSF solution.^{[18-21]} Electrical stimuli thus promote the migration of silk molecules towards the positive electrode, a behavior validated by measured increases in silk concentration within the e-gel mass, relative to the surrounding solution. Independently-evolving pH gradients coincide with this behavior, as the anodic environment gradually approaches the threshold for silk gel formation.

Use of a ring-shaped anode forces the initial gel growth to form as a sheet that is confined to the plane of the electrode and circumscribed by the ring itself. Only after that space is occupied will silk gel develop above and below the initial plane and around the wire. This result is entirely different than what is observed in an incomplete loop, such as one interrupted by a cut, where gel formation envelops the wire uniformly both in and outside of the loop and no film is produced. The difference between these two events reflects the uniqueness of the closed loop result and suggests the role that electric field distribution may play in the e-gel film process, promoting an almost exclusive aggregation of silk mass within the plane of the ring.

Folding the ring allows for e-gel films with unique geometries, enabling silk films with topologies that can not be realized otherwise through existing silk film fabrication methods. The applications for this approach include biosensors and drug delivery devices with unusual geometries that can be molded to fit conformally upon target organs, as well as customized patient-specific tissue engineered scaffolds for curved but stratified tissue architectures. These ideas serve to complement a recent paper that introduced initially flat silk films that conformed to the brain through wetting. However, acceptable conformation to the underlying tissue geometry was only apparent for films less than 7 microns thick.^{[22]}

E-gel films allow for the production of curved films across a range of thicknesses. Films can range from those tens of microns thick to thin films with submicron thickness. Film thickness can be controlled by numerous factors including wire gauge, voltage, silk concentration and exposure time. Thin films are of particular interest as they lend to applications in photonics and optoelectronics. Further, by comparison with other silk film fabrication methods, the electroglelation process allows for more facile fabrication and yields thin films that are easier to manipulate.

Surfaces of e-gel films are extremely smooth. Multiple straight line topographical measurements taken across a 10 μm×10 μm film section with an atomic force microscope (AFM) yielded root-mean-squared (RMS) values between 4-6 Å. On a larger scale, SEM images of a film section with dimensions of the order of a millimeter showed no detectable surface defects. These results are in contrast with results from alternating current (AC) experiments, where the mean roughness was two orders of magnitude higher, suggesting that silk molecules may align themselves in response to the DC field.

Silk films produced via electrogelation are optically transparent, with characteristics similar to those observed in silk films made by other methods. Spectroscopic measurement of optical transmission is in excess of 90% across the visible spectrum for films 20-30 μm thick, which compares favorably to previously reported results for cast silk films. In addition, refractive index measurements of n=1.54 using a commercial refractometer showed little difference from previously published results employing other silk film fabrication techniques.

Previous papers highlight the problematic role that bubble formation plays within the developing e-gel, as the gaseous products of water electroylsis. Electrode geometry is significant. With a rod-shaped anode, oxygen bubbles nucleate upon the electrode's surface and accumulate within the expanding gel, compromising mechanical stiffness and serving as an electrical insulator that retards continued gel formation. At the cathode, hydrogen bubble nucleation takes place at a rate double that of anodic oxygen as per the overall electrolysis reaction:

a. 2H₂O(l)→2H₂(g)+2O₂(g) (3)

Flat ring-shaped anodes avoid significant bubble interference during film formation, an effect that can be explained by geometry: while a film develops within the ring, the silk-metal interface on the outside of the ring does not experience any significant e-gel mass accumulation, allowing bubbles to escape without becoming entrapped within the forming gel. Moreover, the rate of bubble formation can be minimized by regulating electrical current within the solution. It is of note, however, that some three-dimensional configurations result in the entrapment of bubbles, though this effect can be minimized through the use of filters that capture or redirect bubbles away from the developing e-gel film.

Previously, electrogelation was noted for its potential to generate biocompatible adhesive silk as well as for its ability to serve as a complementary process to hydrogels and gels formed via sonication. Here, electrogelation with a closed-loop anode is shown to be a rapid, novel approach for generating silk films that are exceptionally smooth. Further, manipulation of the electrode can confer curvature to the resulting films, something unattainable via alternative methods. Fine control of the fabrication process has shown the capability to generate a range of film thicknesses from tens of microns to hundreds of nanometers, creating interesting opportunities in a number of fields spanning photonics and optoelectronics to biosensing, drug delivery and tissue engineering.

Regenerated silk fibroin (RSF) solution was produced through slight modifications to the standard process [1, 15, 32]. Degumming time within a 0.02 M sodium carbonate solution was limited to a 10 minute boil, shorter than in preceding papers discussing the e-gel process, to minimize fibroin protein degradation [1, 2]. Correspondingly, fibroin was solubilized in 9.3M lithium bromide for 16 hours in a 60° C. oven to allow for more complete unfolding of the comparatively longer fibroin chains. The chaotropic salt was subsequently removed through dialysis (3.5 kDa MWCO) against Milli-Q water for a total of 72 hours, yielding an 8% (w/v) silk solution. The resulting liquid was then purified by centrifugation at 8,800 rpm over two 25-minute long periods, with the temperature held constant at 4° C.

To examine the temporospatial evolution of pH gradients within silk solution exposed to DC current, 5 μL of methyl red indicator dye (Riedel-de-Haen) was added to 2 mL of silk solution. Methyl red is an azo dye that appears red below pH 4.4 and yellow above pH 6.2. The initial RSF pH, measured by short-range pH paper (Micro Essential Lab, Hydrion) was 6.5. Gold-plated rods, 0.6 mm in diameter, were used as electrodes at a separation distance of 5 mm. Video was recorded for 10 minutes at 10V, constant voltage (Mastech, HY3005D-3 DC).

Ring-shaped electrodes were produced from a selection of gold (0.2 mm diameter) and gold-plated (0.6, 0.8 and 1.0 mm diameter) wires (Alfa Aesar and Paramount Wire Company). To assure reproducibility, each anode was created by hand by twisting the wire around rigid plastic cylinders of known diameter, ranging from 7 to 20 mm. Meanwhile, the cathode remained a straight segment of gold wire. For film fabrication, 2 mL of silk solution were deposited into polystyrene tubes prior to introduction of the ring anode and straight cathode. Current was delivered to the solution through a power supply at 5, 10 or 25V, constant voltage, for durations between 0.5-10 minutes. The positive electrode, circumscribing a silk film, was subsequently removed and allowed to air dry. Changes in silk concentration between the e-gel film and the surrounding solution were measured by comparing the wet and dry masses of samples collected following electrical stimluation.

Films were studied using a host of analytical tools. SEM (Carl Zeiss, Ultra55) images were collected, after sputter coating (Cressington, 208HR) with a Pt/Pd target, using both InLens and secondary backscatter detectors. AFM (Veeco, Nanoscope III) images were recorded in air using Research Nanoscope software version 7.30 (Veeco). A 225 mm long silicon cantilever with a spring constant of 3 N/m was used in tapping mode. FTIR spectra were taken using an ATR probe, with subsequent background subtraction.

Optical transmission was measured in software (Ocean Optics, SpectraSuite) using a tungsten-halogen light source (Ocean Optics, LS1) and a visible-range spectrometer (Ocean Optics, USB2000) Refractive index was determined using a commercial refractometer (Metricon, 2010 M prism coupler).

### Example 4

### Exemplary Silk Films

In some embodiments, the properties of the silk fibroin film, such as thickness and content of other components, as well as optical features, may be altered based on the concentration and/or the volume of the silk fibroin solution that is applied to a substrate. For instance, the thickness of the silk film may be controlled by changing the concentration of the silk fibroin in the solution, or by using desired volumes of silk fibroin solution, resulting silk fibroin film with a thickness ranging from approximately 2 nm to 1 mm. In one embodiment, one can spin-coat the silk fibroin onto a substrate to create films having thickness from about 2 nm to about 100 μm using various concentrations of silk fibroin and spinning speeds. The silk fibroin films formed therefrom have excellent surface quality and optical transparency.

In some embodiments, silk film used herein is a free-standing silk film. The silk film may be ultrathin, for instance, up to 100 μm, up to 75 μm, up to 25 μm, up to 7 μm, up to 2.5 μm, or up to 1 μm. Such ultrathin silk films, depending on the casting technique and curing parameters of silk films, may provide soft and flexible films for fabricating silk metamaterial composite that has non-planar structure.

The mechanical property of silk film can be modified by addictives, such as glycerol, to provide a more ductile and flexible silk fibroin film. See, e.g., PCT/US09/060,135, which is incorporated herein by reference in its entirety. Such modification of silk film can be used in many biomedical applications, such as tissue engineering, medical devices or implants, drug delivery, and edible pharmaceutical or food labels.

### Example 5

### Silk Extraction and Purification

The process to obtain aqueous silk fibroin solution from B. mori cocoons was previously described. Briefly, sericin was removed by boiling the cocoons in an aqueous sodium carbonate solution for 30 minutes. After drying, the fibroin fibers were dissolved in a lithium bromide solution and subsequently the salt was removed by dialysis against deionized water (DI) until the solution reached a concentration of about 8-10% wt/v. To enhance the purity of the silk, we centrifuged a second time and filtered the solution through a 5 μm syringe filter (5 μm pore size, Millipore Inc, Bedford, Mass.).

### Example 6

### Reflective and/or Iridescent Particles and Incorporation into Products

Silk films with diffraction gratings can be used to create reflective and/or iridescent particles. In some embodiments, the diffraction gratings can be 1D or 2D gratings. The diffraction gratings can have line pitches that result in high visibility of diffraction. In some embodiments, the line pitch of a diffraction grating can be between about 50 lines/mm to about 1000 lines/mm. In some embodiments, the line pitch of a diffration grating can be 300 lines/mm. In some embodiments, the line pitch of a diffration grating can be 1000 lines/mm.

In some embodiments, a substrate can have one or more patterns corresponding to a 1D or 2D diffraction grating. Exemplary patterns include holographic diffraction grating or blazed diffraction grating. In some embodiments, any aqueous silk fibroin solution described herein can be poured, casted, or spin-coated onto the patterned surface of the substrate. The silk fibroin solution can be left to dry at room temperature, by way of example. As the solution dries, the silk proteins self-assemble around the pattern such that a surface of the resulting silk film matches the pattern of the substrate. The silk film can be peeled off the substrate.

The silk film with diffraction gratings can be presented to a grinding machine. A rotating blade of the grinding machine can pulverize the silk film into particles. In some embodiments, the rotating blade can pulverize the silk film into particles that retain the optical properties of the diffraction grating. For example, the silk particles can continue to exhibit the reflectivity or iridescence of the original silk film with diffraction gratings patterned thereon.

The silk particles can be incorporated into any substance to add an iridescent or reflective effect. For example, the silk particles can be incorporated into cosmetic products, such as powders, pressed powders, liquids, emulsions, creams, lotions, gels, aerosols, ointments, and/or solid sticks. Silk particles can be incorporated into paints, such as industrial paint used for signage or commercial paints for childrens' use, for a radiant effect. Silk particles can be incorporated into textiles to add an iridescent effect to articles of clothing, by way of example.

### Example 7

### Colored Particles and Incorporation into Products

Silk films with 2D arrays of holes and/or pits can be used to create colored particles. The silk films can be photonic devices that transmit and/or reflect desired wavelengths of light. In some embodiments, the diameters of the holes or pits can be between about 150 nm and about 300. In some embodiments, the depths of the holes or pits can be between about 30 nm to several microns deep. Holes or pits can be machined into surfaces of silk films by, for example, applying femtosecond laser pulses from a laser, according to any method described herein.

In some embodiments, the distance between the holes or pits (e.g., the lattic constant) on the silk film can affect the wavelength of light reflected by the silk film and thus, the color that appears to an observer. The distance between the holes or pits can be measured as the distance between the centers of the holes or pits. Without wishing to be bound by theory, the color can be determined by considering the observation angle of the structure and applying the Bragg equation:

$$λ = \frac{Λ}{m} ( {n}_{1} sin {θ}_{inc} + {n}_{2} sin {θ}_{dif} ) , m = 0 , \pm 1 , \pm 2$$

wherein Λ is the lattice (grating) constant, λ is the wavelength of the incident light, θ_{inc} and θ_{dif} are the incident and diffracted angles (measured with respect to the normal to the grating surface), m is the diffraction order and n₁ and n₂ are the refractive indices of the surrounding media and of the silk, respectively.

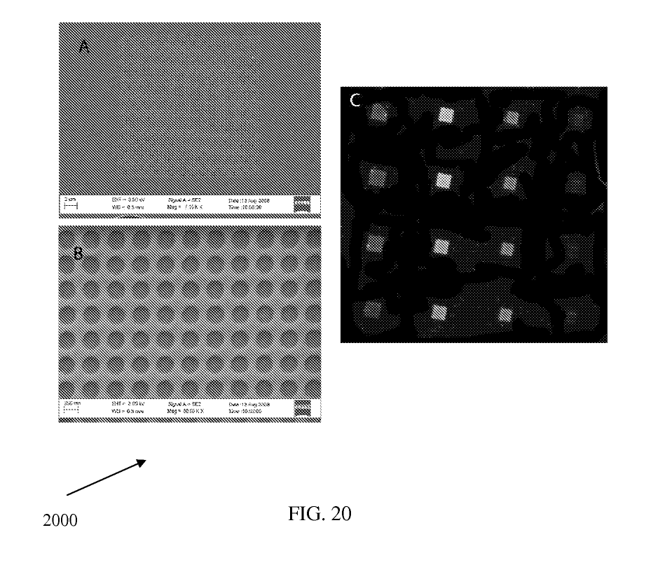

FIG. 20 depicts an exemplary silk film that can be used to create particles that exhibit colors. Section A of FIG. 20 depicts a silk film with periodic nanoholes. The nanoholes are 200 nm in diameter, 30 nm deep, and separated by 300 nm. Section B depicts a magnified image of Section A. Section C depicts the patterns of light generated by illuminating silk films, such as those of Section A, but with different lattice constants. The lattice constants of the silk films being illuminated are 700, 600, 500, and 400 nm. The distance between the rows of colored squares is 200 μm.

Silk films with structurally defined color via holes/pits can be ground into particles and incorporated into other substances. For example, the silk particles can be incorporated into cosmetic products, such as powders, pressed powders, liquids, emulsions, creams, lotions, gels, aerosols, ointments, and/or solid sticks. In some embodiments, silk particles exhibiting a color that matches a shade of human skin can be incorporated into a cosmetic powder. Application of cosmetic powder can improve the appear of a human complexion. In some embodiments, silk particles exhibiting colors suitable for various cosmetics (e.g., bronzer, blush, lipstick, eyeshadow) can be incorporated into the formulations for such products. In other examples, silk particles can be incorporated into paints, such as industrial paint used for signage or commercial paints for childrens' use, to provide the color of the paint.

### Example 8

### Reflective Particles Based on Microprisms and Incorporation into Products

Silk films with prisms (e.g., microprisms) can be used to create reflective particles. Microprisms that can be used as reflectors or retroflectors can have dimensions between about 10 μm and about 150 μm. The dimensions can have a 1:1 aspect ratio. Microprisms can be designed to reflect any wavelength of light. In some embodiments, microprisms can reflect all wavelengths of visible light. In some embodiments, microprisms can reflect ultraviolet light.

In some embodiments, silk films with microprisms can be created by pouring, casting, or spin-coating an aqueous silk fibroin solution onto a substrate with a pattern conforming to a microprism and drying the solution into a silk film. A chopping machine can chop the silk film into a powder with individual or clustered microprisms. The powder can be incorporated into other substances and applied to surfaces for which reflection of light can be advantageous.

For example, particles tailored to reflect ultraviolet light can be incorporated into a cream to create a sunscreen composition. The same particles can be incorporated into a coating and applied to produce. The reflection of ultraviolet light off the produce can moderate the temperature of the produce. The same particles can be incorporated into a sealant and applied to exteriors of buildings. The reflection of ultraviolet light off the buildings can moderate the absorption of energy from the sun, thereby reducing utility costs for cooling a building. In some embodiments, particles tailored to reflect desired wavelengths of visible light can be incorporated into any composition for colorant, as described herein.

### Example 9

### Filtering/Reflective Particles Based on Stacks of Silk Films and Incorporation into Products

Stacks of silk films with different doping agents and different levels of doping can be used to create filtering or reflective particles. Adjacent silk films in the stack can exhibit sufficient index contrast (e.g., the difference in index of refraction Δn between the adjacent silk films). These values can vary from Δn=0.001 to 0.02 in cases of purely organic dopants such as fluorescin or melanin. In some embodiments, some of the silk films in the stacks are undoped. In some embodiments, all of the silk films are doped. In some embodiments, adjacent silk films have different doping agents and/or different levels of doping. The index contrast between layers of silk can be tailor to create a stack of silk films that filter or reflect desired wavelengths. In some embodiments, the silk films can be bonded together with, for example, any chemical adhesive described herein. In some embodiments, the silk films can be bonded together by applying water to partially dissolve the silk films so the films adhere to one another.

The stacks of silk films can be ground into particles, incorporated into other substances, and applied to surfaces for which reflection of light can be advantageous, as described herein.

### Example 10

### Solar Concentrators

Silk films with lenses can be used to create solar concentrators. In some embodiments, the lens can focus incident light onto a surface. A silk film with an array of lenses can be formed according to any of the techniques described herein. In some embodiments, each lens in the array can have dimensions between about 50×50 μm and about 2×2 mm. In some embodiments, each lens can have a focal length between about 1 mm and about 20 cm. In some embodiments, the lens can be formed on a silk film with dimensions between about 100×100 μm and about 90×90 mm. The dimensions of the lenses and silk films described herein are merely exemplary; other dimensions can be used.

Silk films can be indexed cleaved. Blades of a chopping machine can be aligned in between lens on the silk films. Thus, a chopping machine can transform a silk film with lens into silk particles, each particle having at least one lens patterned thereon. The particles can be dispersed in a coating. The coating can be applied to a surface of any object upon which energy shall be focused. For example, the coating can be applied to a solar cell. The lens focuses incident light from the sun onto a surface of a photovoltaic cell, which can generate energy from the light.

### Example 11

### Solar Concentrators

Silk films with lens can be used to create solar concentrators. In some embodiments, the lens can focus incident light onto a surface. A silk film with an array of lenses can be formed according to any of the techniques described herein. In some embodiments, each lens in the array can have dimensions between about 50×50 μm and about 2×2 mm. In some embodiments, each lens can have a focal length between about 1 mm and about 20 cm. In some embodiments, the lens can be formed on a silk film with dimensions between about 100×100 μm and about 90×90 mm. The dimensions of the lenses and silk films described herein are merely exemplary; other dimensions can be used.

The example presented herein relates to fabrication and uses of silk particles having at least one optical property. For example, the silk particles are designed with a diffractive property, rendering it iridescent. Applications of such diffractive silk powder include, but are not limited to, cosmetics, novelties, medical agents, clothing and textiles, as well as sign and displays. Throughout this application, various publications are referenced. The disclosures of all of the publications and those references cited within those publications in their entireties are hereby incorporated by reference into this application in order to more fully describe the state of the art to which this invention pertains. The following examples are not intended to limit the scope of the paragraphs to the invention, but are rather intended to be exemplary of certain embodiments. Any variations in the exemplified methods which occur to the skilled artisan are intended to fall within the scope of the present invention.

### Example 12

### Applications of Silk Optical Powder

Since silk is all-water processed, its key attributes are natural, pure protein that is safe and biocompatible, and controlled degradability. Without wishing to be bound by theory, the biocompatible and implantable nature silk combined with the ability of reforming films into optical components on the micro and nanoscale enables optical powder to manipulate light while being dispersed in an external environment. The silk optical powder described herein can yield several products in the cosmetic, novelty items and in medical industries. These products are based on bringing together (a) optical quality silk with various surface patterns to modify light, (b) biocompatibility of the silk, (c) dispersibility in the environment without any environmental damage due to the all degradable nature of the material, and (d) enzymatic digestion in the body. These products can be developed in a number of ways, from films that are then machined or processed into powders, e.g., as described in Example 1, from patterned fibers that are then chopped or fragmented, or from related approaches.

Cosmetic Applications:

A variety of cosmetic creams, lip balms, powders, etc., exist on the market today and provide a glittering effect. Typically, such effect is obtained by using generally regarded as safe but inorganic additives such as silica, titanium dioxide, mica, iron oxides, and the like. The silk powder of the invention can provide the same glittering effect in cosmetic products without the use of any external additives, and thus provide an all-organic alternative. Further, the use of heavy metals or inorganics in cosmetic products to provide a glittering effect can be avoided.

In some embodiments, particle composition comprising silk particles optical properties that provide desirable iridescence or goniochromatic effect, which can be particularly suitable for cosmetic and other topical applications. Unlike prior art formulations that comprise monodisperse particles or colloidal crystalline, the synthesis of these particles is costly and involves the use of harsh chemicals.

In some embodiments, silk particle compositions suitable for use as cosmetic products such as sunscreen lotion are made from silk films that incorporate silk fibroin comprising at least one mutation. The natural absorption of tyrosines, which is in the ultraviolet region, provides filtering in the short UVB and UVC regions of the spectrum. Thus, UV protection and glitter effects can be combined in cosmetic products. In some embodiments, silk fibroin with at least one mutation contains more tyrosine residues than native silk fibroin proteins. For example, such silk fibroin may contain 1, 2, 3, 4, 5, 6, 7, 8, 9, 10, 11, 12, 13, 14, 15, 16, 17, 18, 19, 20, or more tyrisone residues in the silk fibroin polypeptide sequence than the native counterpart.

The medium may be transparent or translucent, and may optionally be colored. The medium containing the silk particle composition does not need to contain a pigment or colorant. The coloration of the medium may correspond to addition of an additional coloring agent.

The color of the medium corresponds, for example, to one of the colors that are capable of being generated by the silk particle composition, for example the color produced by the silk particles when observed under normal incidence.

Filtering, and, therefore, solar blocking and solar protection can be obtained by designing a multi-layered silk structures which are tuned to reflect specific wavelengths. Different pure-protein-based powders can be mixed to obtain the desired effects.

Photonic crystals that generate structural color can provide an all-natural, chemical-free path cosmetics where nanostructure defines the color appearance, in contrast to the many additive present in the art today. A protein-based colorimetric powder can be used to provide color balms and enhance their cosmetic value in all-organic fashion.

Novelty Applications:

Optical powders such as glitter for children, or for arts and crafts applications can be rendered edible and harmless. A number of craft products based on reflective surfaces and embellishment can be achieved without concern for contamination, either from manipulation (e.g., via dermal contact), or ingestion.

Medical Applications:

Optical powder can provide an all natural contrast agent for imaging applications. For example, the powder can be injected without any need to retrieve it since it undergoes enzymatic digestion inside the body. This is particularly appealing for imaging modalites that are (but not limited to) low contrast such as diffuse scattering non-invasive methods.

Further, photonic crystal powder can be used to inject a specific spectral response into the body, thereby assigning a specific spectral signature that can be effectively detected.

Clothing and Textiles:

Addition of optical powder to textiles of all kinds offers novel color features, glitter, and related features, as well as dynamic displays. The powders can be either added to surface of textiles, e.g., by electrostatics or with glues, or processed into the textiles during manufacture.

Signs and Displays:

Availability of an all-organic degradable set of colors can offer novel ways to prepare and display signs and information that would be temporary, decorative and dynamic.

It is understood that the foregoing detailed description and examples are illustrative only and are not to be taken as limitations upon the scope of the invention. Various changes and modifications to the disclosed embodiments, which will be apparent to those of skill in the art, may be made without departing from the spirit and scope of the present invention. Further, all patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

1. A silk particle composition comprising a population of silk particles of about 2 nm to 1 mm in dimension, having at least one of the following optical properties:
(a) reflectivity
(b) diffraction
(c) refraction
(d) absorption
(e) optical gain
(f) fluorescence
(g) iridescence
(h) light scattering
wherein the optical properties are present on at least one surface of the silk particle.

2. The silk particle composition of claim 1,
wherein the silk particles have a diffraction grating on the first surface, and
wherein the diffraction grating has a line pitch between about 50 lines/mm and about 1000 lines/mm.

3. The silk particle composition of claim 2, wherein the diffraction grating is about 300 lines/mm.

4. The silk particle composition of claim 3, wherein the diffraction grating is about 1000 lines/mm.

5. The silk particle composition of claim 2, wherein the diffraction grating is a ID diffraction grating.

6. The silk particle composition of claim 2, wherein the diffraction grating is a 2D diffraction grating.

7. The silk particle composition of claim 1,
wherein the silk particles have holes on a first surface, wherein the holes are separate by a distance between about 300 nm and about 700 nm.

8. The silk particle composition of claim 7, wherein the distance is 300 nm, 400 nm, 500 nm, 600 nm, or 700 nm.

9. The silk particle composition of claim 7, wherein diameters of the holes are between about 150 nm and about 300 nm.

10. The silk particle composition of claim 7, wherein depths of the holes are between about 30 nm and about 50 μm.

11. The silk particle composition of claim 1,
wherein the silk particles comprise a prism with a dimension between about 10 μm and about 150 μm and aspect ratio of about 1:1.

12. The silk particle composition of claim 1,
wherein the silk particles comprise a fragment of a stack of silk films,
wherein difference in indices of refraction of adjacent silk films is between about 0.001 and about 0.02.

13. The silk particle composition of claim 12, wherein all of the silk films comprise dopants.

14. The silk particle composition of claim 12, wherein some of the silk films comprise dopants.

15. The silk particle composition of claim 1,
wherein the silk particles comprise a lens with dimensions between about 50×50 μm and about 2×2 mm.

16. The silk particle composition of claim 15, wherein the lens has a focal length between about 1 mm and about 20 cm.

17. The silk particle composition of claim 1, comprising a pharmaceutically or cosmetically acceptable carrier.

18. The composition of claim 17, further comprising an agent.

19. The composition of claim 18, wherein the agent is embedded into the particles.

20. The composition of claim 18, wherein the agent is a targeting agent which binds to a target molecule.

21. The composition of claim 20, wherein the target molecule is a pathogen, antibody, antigen, or any combination thereof.

22. (canceled)

23. (canceled)

24. The composition of claim 18, wherein the agent is a therapeutic agent.

25. The silk particle composition of claim 1 formulated as a sunscreen composition.

26. The silk particle composition of claim 1 formulated as a cosmetic composition.

27. The silk particle composition of claim 1 formulated as an optical coating.

28. The silk particle composition of claim 1 formulated as a paint.

29. The silk particle composition of claim 1 formulated as a textile.

30. A method for making a silk optical particle, the method comprising:
providing a first surface of a solid-state silk material having a smoothness less than about 10 nm;
fabricating a pattern on the first surface, the pattern corresponding to an optical device that exhibits at least one of reflectivity, retro-reflectivity, diffraction, refraction, and absorption; and,
reducing the solid-state silk material with the pattern on the first surface into a particle composition comprising silk particles,
wherein a dimension of the silk particle is less-than about 1000 μm.

31. The method of claim 30, wherein the smoothness of the first surface is between about 1 nm and about 10 nm.

32. The method of claim 30, wherein the optical device reflects light between about 10 nm and about 400 nm.

33. The method of claim 30, wherein the optical device absorbs light between about 10 nm and about 400 nm.

34. The method of claim 30, wherein the optical device reflects light between about 380 nm and about 780 nm.

35. (canceled)

36. The method of claim 30, wherein the optical device comprises at least one of a lens, lens array, microlens array, optical grating, diffraction grating, photonic crystal, 1-D grating, 2-D grating, prism, microprism array, reflector, and retroreflector.

37. The method of claim 30, further comprising a second surface with a smoothness less than about 10 nm.
